(19) United States
(12) Patent Application Publication
(10) Pub. No.: US 2004/0110102 A1
(43) Pub. Date: Jun. 10, 2004

(54) Concentrated bleach-fixer composition for silver halide color photographic material

(75) Inventors: Satoshi Okano, Tokyo (JP); Kouki Kawashima, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Holdings, Inc., Tokyo (JP)

(21) Appl. No.: 10/725,310

(22) Filed: Dec. 1, 2003

(30) Foreign Application Priority Data
Dec. 6, 2002 (JP) JP2002-354699
Feb. 24, 2003 (JP) JP2003-045394

(51) Int. Cl. G03C 7/42

(52) U.S. Cl. 430/460; 430/393

(57) ABSTRACT

A concentrated bleach-fixer composition for a silver halide color photographic material is disclosed, comprising an aminopolycarboxylic acid iron complex and a thiosulfate, wherein the bleach-fixer composition further comprises at least one compound selected from a phosphate salt, polyphosphate salt, an imidazole compound and a diaminotriazine compound; and the aminopolycarboxylic acid iron complex having a Fe(II) ratio of not less than 50 mol %.

### FIELD OF THE INVENTION

The present invention relates to a concentrated bleach-fixer composition for a silver halide color photographic material (hereinafter, also denoted as photographic material) of a concentrated bleach-fixer composition of a single part constitution for a silver halide color photographic material, its package and a processing method by the use of the same, and in particular to a concentrated bleach-fixer composition preventing deterioration in photographic quality, such as deteriorated background whiteness in prints obtained in running process after being stored over a long period of time or staining caused by aging, achieving superior processing performance, and its package and a processing method by the use of the same.

### BACKGROUND OF THE INVENTION

Bleach-fixer composition is used to remove developed silver in processing photographic materials. The process for removing developed silver includes a bleaching step of oxidizing silver grains using oxidizing agents to form silver ions and a fixing step of leaching out silver ions produced by oxidation from photographic material. Accordingly, a bleach-fixer contains a bleaching agent and a fixing agent. Fixing gents generally have reducing ability, which are easily deactivated upon reaction when a preservative is not concurrently present. Sulfites are usually used as a preservative, however, such a preservative decomposes with age and even when a preservative is present, the bleaching agent and preservative react with each other at a relatively high concentration, leading to deteriorated performance. In light of the foregoing, a bleaching agent part and fixing agent part are conventionally designed as two-part constitution.

Handling plural parts often increases complicated and troublesome work for users. Specifically, a mistaken operation in dissolution produces problems that an intended replenishing concentration is not achieved. A replenisher of a single part constitution (so-called one-part) is therefore desired by users, which includes all replenishing components together and is usable as a replenisher. The one-part gets rid of such a troublesome work, markedly reducing possibility of causing a mistake in the dissolution operation. There are known two types of one-part replenisher, including a worker type which is usable as a replenisher in that form and a concentrate type which is diluted with water to use as a replenisher.

Recently, small-scale photographic labs, so-called mini-labs having a relatively small store area increase, in which a space for stocking replenisher solutions is limited and a concentrated solution type capable of being finished even in a relatively small space for stock is desired rather than a worker solution type which needs a relatively large space for stock.

There are known concentrated bleach-fixer compositions of one-part type, including a concentrated bleach-fixer compositio, which comprises either one or both of ethylenediaminesuccinic acid iron(III) complex and ethylenediamineglutamic acid iron(III) complex which is packed in a vessel exhibiting an oxygen supplying speed of less than 10 ml/hr per liter of contents, as described, for example, in JP-A No. 2000-98553 (hereinafter, the term, JP-A refers to Japanese Patent Application Publication); a bleach-fixer precursor composition comprising (a1) at least 0.05 mol/l of an iron-coordinated complex, (a2) at least 0.15 mol/l of at least one kind of thiosulfate and (a3) at least a sulfite salt and having a pH of 4 to 10, in which at least 50 mol % of irons is in the form of iron(II), as described, for example, in JP-A No. 2002-169253; a concentrated bleach-fixer composition of a one-part type comprising an iron(II) complex, thiosulfate and sulfite salts, and a disulfite or sulfonic acid, which further contains at least a compound selected from a phosphate, polyphosphate or polyphosphonic acid salt, and a nitrate or bromide, as described, for example, in JP-A No. 2002-1449. The foregoing JP-A No. 2000-98553 also describes improvements in process stability at high temperature and bottle-staining and superior bleach-fixing ability; JP-A No. 2002-169253 describes improvements in precipitation at low temperature, solution stability at high temperature and bleach0fixing ability in running process; JP-A No. 2002-1449 also describes improvements in precipitation at low temperature and solution stability at high temperature.

However, it was proved that, in addition to the foregoing solution stability and bleaching stability after storage at high or low temperature, a one-part type bleach-fixer composition further arose problems that deteriorated photographic quality occurred, such as background whiteness of prints occurred in running process after storage over a long period of time and staining caused by aging.

Further, reducing the replenishing rate has proceeded to lower the cost for disposal and treatment, taking into account of global natural environment together with responding to desire for rapid processing. Spectral sensitizing dyes which are included in photographic material to provide sensitivity to visible light and which are to be leached out of photographic material during processing, are often insufficiently removed and remain in the photographic material, causing troubles on the market, such as edge staining, in which staining occurs in edge portions of photographic material. Accordingly, there has been desired a countermeasure to cope with such troubles as edge staining, even when subjected to rapid processing at a relatively low replenishing rate.

There have been some proposals to overcome staining in photographic material, caused by spectral sensitizing dyes remained in photographic material. There are known processing compositions containing compounds to reduce staining due to dyes remained in the processed photographic material, for example, diaminostilbenesulfonic acid type compounds described in JP-A No. 2001-281823 (hereinafter, the term, JP-A refers to Japanese Patent Application Publication) and triazine type compounds described in JP-A No. 2001-174957.

However, it was proved that only incorporation of such compounds was insufficient to overcome staining in photographic material caused by residual dyes, specifically, edge stain. There are worldwide used concentrated bleach-fixer compositions in mini-labs, which are contemplated to be used under any climate environment. Specifically in cases when used as a replenisher prepared by dilution of the concentrated composition after storage over a long period of time in relatively high temperature districts, it was proved that problems such as marked edge staining often occurred.

### SUMMARY OF THE INVENTION

It is an object of the present invention to provide a concentrated bleach-fixer composition of a single part constitution for a silver halide color photographic material, its package and a processing method by the use of the same, and in particular to a concentrated bleach-fixer composition preventing deterioration in photographic quality, such as deteriorated background whiteness in prints obtained in running process after being stored over a long period of time or staining caused by aging, achieving superior processing performance, and its package and a processing method by the use of the same.

The foregoing problem can be achieved by the following constitution.

1. A concentrated bleach-fixer composition for a silver halide color photographic material of a single part constitution, comprising an aminopolycarboxylic acid iron complex and a thiosulfate, wherein the concentrated bleach-fixer composition further comprises at least one compound selected from the group consisting of a phosphate salt, polyphosphate salt, an imidazole compound and a diaminotriazine compound; and the aminopolycarboxylic acid iron complex having a Fe(II) ratio of not less than 50 mol %.

The invention also provides a method of processing a silver halide color photographic material comprising bleach-fixing an imagewise exposed and developed silver halide color photographic material with a concentrated bleach-fixer composition described above.

### EMBODIMENTS OF THE INVENTION

In general, aminopolycarboxylic acid iron complexes for use in silver halide color photographic material are formed from an iron salt and one or more aminopolycarboxylic acids as ligands An aminopolycarboxylic acid iron complex used in this invention is mainly comprised of ethylenediaminetetraacetic acid as a ligand or its alkali metal salt (e.g., lithium salt, sodium salt, potassium salt) or ammonium salt. Other aminopolycarboxylic acids may be included to enhance stability of a chelate structure or rapid processability. Examples of other aminopolycarboxylic acids include diethylenetriaminepentaacetic acid, ethylenediamine-N,N′,N′-triacetic acid, 1,2-diaminopropanetetraacetic acid, 1,3-diaminopropanetetraacetic acid, nitrilotriacetic acid, cyclohexanediaminetetraacetic acid, iminodiacetic acid, dihydroxyethyleneglycine, ethyl-ether-diaminetetraacetic acid, glycol-ether-diaminetetraacetic acid, ethylenediaminetetrapropionic acid, phenylenediaminetetraacetic acid, 1,3-diaminopropanol-N,N,N′,N′-tetramethylenephosphonic acid, ethylenediamine-N,N,N′,N′-tetramethylenephosphonic acid, 1,3-propylenediamine-N,N,N′,N′-tetramethylenephosphonic acid, nitrilodiacetic acid monopropionic acid, nitrilomonoacetic acid dipropionic acid, 2-(bis0carboxymethyl-amino)-propionic acid, 2-hydroxy-3-aminopropionic acid-N,N-diacetic acid, serine-N,N-diacetic acid, 2-methyl-cerine-N,N-diacetic acid, 2-hydroxymethyl-serine-N,N-diacetic acid, hydroxyethyliminodiacetic acid, methyliminodiacetic acid, N-(2-acetoamido)-iminodiacetic acid, nitrilotripropionic acid, ethylenediaminediacetic acid, ethylenediaminedipropionic acid, 1,4-diaminobutanetetraacetic acid, 2-methyl-1,3-diaminopropanetetraacetic acid, 2,2-dimethyl-1,3-diaminopropanetetraacetic acid, citric acid and their alkali metal salts (e.g., lithium salt, sodium salt, potassium salt) and ammonium salts. Two or more of other aminopolycarboxylic acids may be used in combination.

The proportion (expressed in terms of molar percentage) of ethylenediaminetetraacetic acid (hereinafter, also denoted as EDTA ratio) is preferably at least 80 mol % of the total amount of aminopolycarboxylic acids as ligands forming the iron complex and thereby advantageous effects of this invention can be achieved. It is more preferred that substantially 100 mol % of the ligand forming the iron complex (aminopolycarboxylic acid) be ethylenediaminetetraacetic acid. The molar percentage of ethylenediamine-tetraacetic acid is the more, the more preferable, thereby achieving effects of this invention in promoting the stabilization process.

As described above, aminopolycarboxylic acid iron complexes for use in photographic material are composed of iron and one or more aminopolycarboxylic acids as ligands. The iron exists chemically in a state of a tri-valent iron(III) [also denoted as Fe(III)] and in a state of a di-valent iron(II) [also denoted Fe(II)]. Aminopolycarboxylic acid iron(III) complexes are inferior in chemical stability when being aged at high temperature over a long period of time, easily causing decarboxylation of the aminopolycarboxylic acid and leading to lowered chelation of the aminopolycarboxylic acid for iron, as compared to aminopolycarboxylic acid iron(II) complexes. As a result, an oxidizing ability of the aminopolycarboxylic acid iron complex is lowered and the use of a concentrated bleach-fixer composition kit of such a state results in residual dyes, leading to edge stains.

In this invention, at least 50 mol % of an aminopolycarboxylic acid iron complex is an iron(II) complex. Hereinafter, the molar ratio of an iron (II) complex to the entire iron complex is also denoted as a Fe(II) ratio, expressed in mol %.

An aminopolycarboxylic acid iron(III) complex may be reduced with a reducing agent such as dithionous acid sodium salt to achieve a Fe(II) ratio of at least 50 mol %. Alternatively, it can be achieved by adjusting the ratio of inorganic Fe (II) salt (or ferrous salt) to Fe(III) salt (or ferric salt). The Fe(II) ratio is preferably at least 80 mol %, thereby leading to further enhanced effects of this invention.

Ferrous salts include, for example, ferrous sulfate, ferrous chloride, ferrous oxalate, and ferrous oxide. Specific examples thereof include ammonium ferrous sulfate, sodium ferrous sulfate, ferrous chloride, ferrous sulfate, ferrous acetate, ferrous oxalate, and ferrous oxide. Ferric salts include, for example, ferric nitrate, ferric chloride, ferric bromide, and Fe(III)sulfate tri M1 salts (in which M1 is ammonium, potassium, sodium or hydrogen). Specific examples thereof include ferric nitrate, ferric chloride, ferric bromide, triammonium iron(III) trisulfate, tripotassium iron(III) trisulfate, trisodium iron(III) trisulfate, potassium iron(III) sulfate, sodium iron(III) sulfate, and ammonium iron(III) sulfate.

The molar ratio of aminopolycarboxylic acid to iron ion is preferably within the range of 1.01:1.00 to 1.08:1.00, and more preferably 1.02:1.00 to 1.06:1.00 in terms of stability of chelate structure and low volume processing. The quantity of iron ions is preferably 0.5 to 4.0 mol, and more preferably 0.5 to 3.0 mol per liter of a concentrated bleach-fixed composition in terms of solubility. There may be incorporated other Fe(III) chelate type bleaching agents as a bleaching agent.

Imidazole compounds used in this invention is preferably a compound represented by the following formula (1) or its derivatives:

(R1)ₙA formula (1)

wherein R1 is a hydrogen atom, an alkyl group having 1 to 3 carbon atom, which may be substituted by an amino group or hydroxy group (i.e., amino- or hydroxy-substituted alkyl group), an alkenyl group (having 2 or more carbon atoms) or a halogen atom, provided that plural R1s may be the same or different. The amino group may be substituted by one or two methyl or ethyl group; and the alkyl or alkenyl group may be substituted by an alkyl group having 1 to 3 carbon atoms; n is an integer of 1 to 3; A is an imidazole moiety.

Specific examples of imidazole compounds represented by the foregoing formula (1) are shown below but are not limited to these:

1-methylimidazole,

2-methylimidazole,

4-methylimidazole,

4-(2-hydroxyethyl)imidazole,

4-(2-aminoethyl)imidazole,

2-(2-hydroxyethyl)imidazole,

2-ethylimidazole,

2-vinylimidazole,

4-propylimidazole,

2,4-dimethylimidazole,

2-chloroimidazole,

4,5-di(2-hydroxyethyl)imidazole, and imidazole.

Phosphate salts and polyphosphate salts are used in this invention. Specific examples of phosphate salts include ammonium dihydrogen phosphate, diammonium hydrogen phosphate, triammonium phosphate, potassium dihydrogen phosphate, dipotassium hydrogen phosphate, tripotassium phosphate, sodium dihydrogen phosphate, disodium hydrogen phosphate, trisodium phosphate, and free phosphoric acid is also usable, but phosphate salts usable in this invention are by no means limited to the foregoing phosphate salts.

Specific examples of polyphosphate salts include sodium hexametaphosphate, sodium tetraphosphate, hydroxyethanediphosphonic acid, salts of N-(2-carboxyethyl)-1-aminoethane-1,1-diphosphonic acid, N,N-bis-(carboxymethylene)-1-aminoethane-1,1-diphosphonic acid, morpholinomethane-diphosphonic acid, nitrilotrismethylenephosphonic acid, ethylenediaminetetramethylenephosphonic acid, hexamethylenediaminetetramethylenephosphonic acid, 2-phosphonobutane-1,2,4-tricarboxylic acid, 2-carboxyethane-phosphonic acid and methylenephosphonic acid, and free polyphosphonic acids.

The imidazole or its derivatives, phosphate salt and polyphosphate salt may be used alone or in combination of two or more of them. To display advantageous effects of this invention, the foregoing compound is used preferably in an amount of 0.01 to 2.5 mol, and more preferably 0.05 to 1.0 mol per liter of a concentrated bleach-fixer composition. An amount of less than 0.01 mol per liter results in deficient effects of this invention and an amount of more than 2.50 mol per liter is not expected to results in further enhanced effect of the invention, even when further concentrated, leading to economical disadvantages.

In one embodiment of this invention, the concentrated bleach-fixer composition contains a diaminotriazine compound. Allowing such a compound to be contained prevents staining caused by residual dyes in photographic material, resulting in synergic effects. The diminotriazine compound usable in this invention is preferably a compound represented by the following formula (I), (II) or (III):

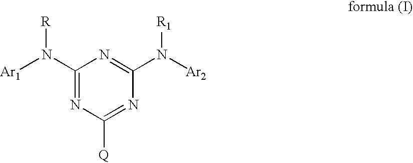

wherein Ar₁ and Ar₂ are independently an aromatic carbocyclic group or an aromatic heterocyclic group, provided that at least one of Ar₁ and Ar₂ contains at least two water-solubilizing groups, or each of Ar₁ and Ar₂ contains at least one water-solubilizing group; Q is a hydrogen atom, hydroxy group, mercapto group, carboxyl group, sulfo group, —NR₂R₃, —OR₂ or a halogen atom, in which R₂ and R₃ are each a hydrogen atom, an alkyl group or a phenyl group; R and R₁ are independently an alkyl group having 1 to 3 carbon atom or a hydroxyalkyl group having 1 to 3 carbon atoms;

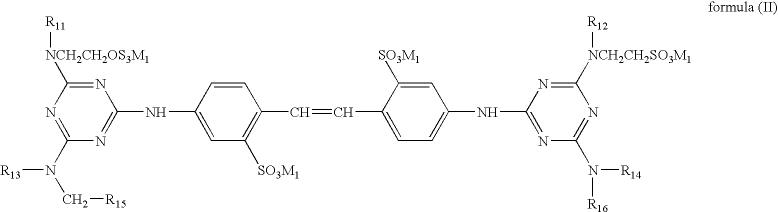

wherein R₁₁ and R₁₂ are independently a hydrogen atom or an alkyl group; R₁₃ and R₁₄ are independently a hydrogen atom, an alkyl group or an aryl group; R₁₅ is an alkyl group containing at least one asymmetric carbon atom or a group represented by the following formula (II-a); R₁₆ is an alkyl group containing at least one asymmetric carbon atom or a group represented by the following formula (II-b); M₁ is a hydrogen atom, an alkali metal atom, an alkaline earth metal atom, ammonium group or a pyridinium group; provided that R₁₃ and R₁₅, or R₁₄ and R₁₆ may combine with each other to form a ring:

—CH₂O(CH₂CH₂O)ₙ₁₁H formula (II-a)

wherein n11 is an integer of 1 to 3;

—(CH₂CH₂O)ₙ₁₂H formula (II-b)

wherein n12 is an integer of 2 to 4;

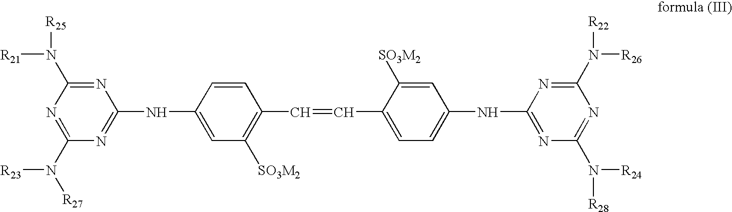

wherein R₂₁, R₂₂, R₂₃ and R₂₄ are independently a hydrogen atom, an alkyl group or an aryl group; R₂₅ and R₂₆ are independently an alkyl group containing at least one asymmetric carbon atom or a group represented by the following formula (III-a); R₂₇ and R₂₈ are independently an alkyl group containing at least one asymmetric carbon atom; M₂ is a hydrogen atom, an alkali metal atom, an alkaline earth metal atom, ammonium group or a pyridinium group; provided that R₂₁ and R₂₅, R₂₂ and R₂₆, R₂₃ and R₂₇, or R₂₄ and R₂₈ may combine with each other to form a ring:

—(CH₂CH₂O)ₙ₂₁H formula (III-a)

wherein n21 is an integer of 2 to 4.

In the foregoing formula (III), the water-solubilizing group refers to a group promoting solubility in water. Specific examples of the water-solubilizing group include —SO₃M, —COOM, —OH and a group containing at least one of —SO₃M, —COOM and —OH, in which M is a hydrogen atom, alkali metal atom, alkaline earth metal atom, ammonium group or pyridinium group.

Specific examples of the foregoing compounds are shown below but are by no means limited to these examples.

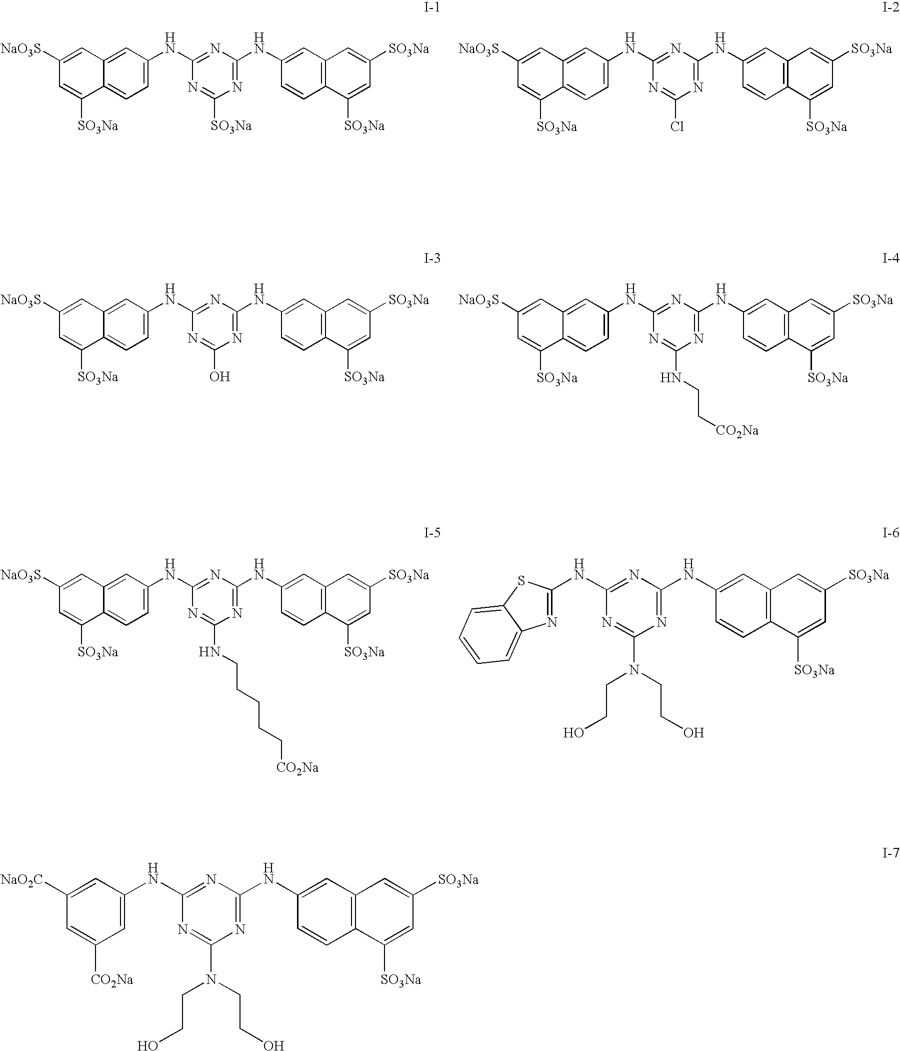

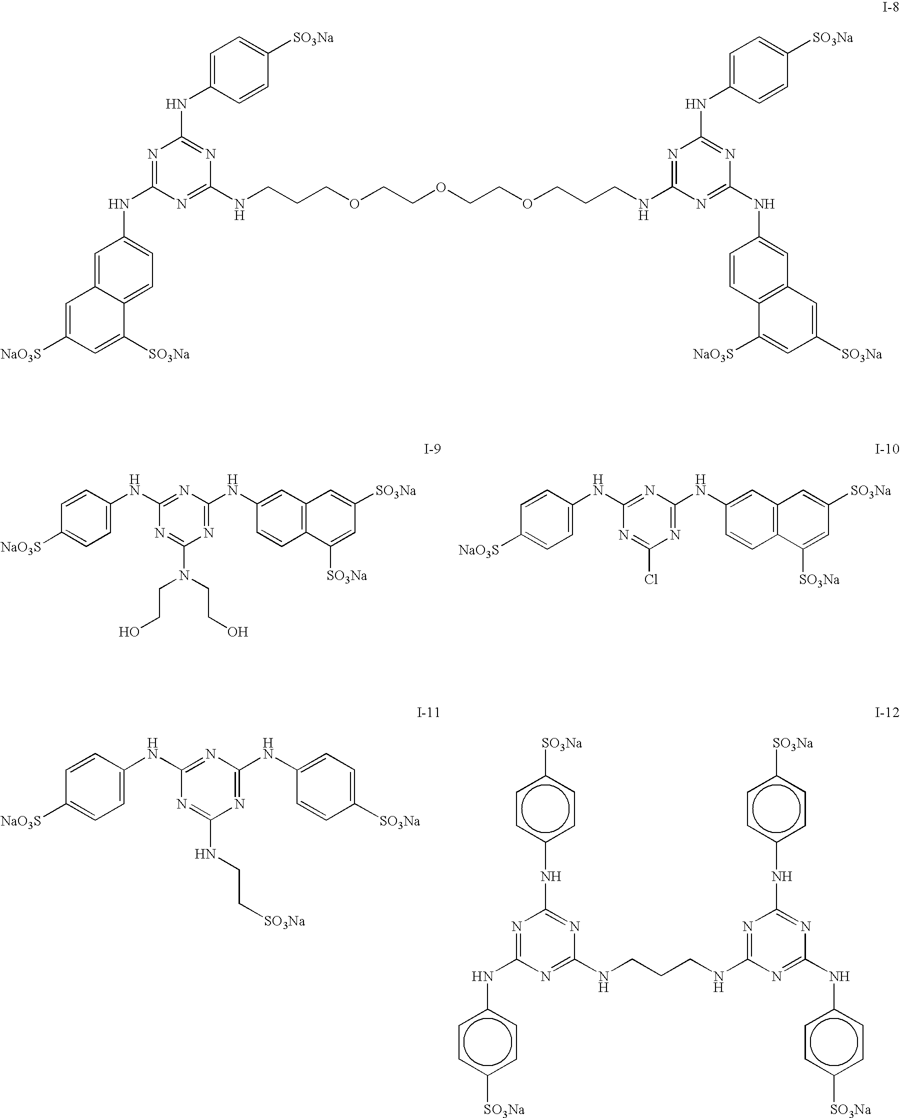

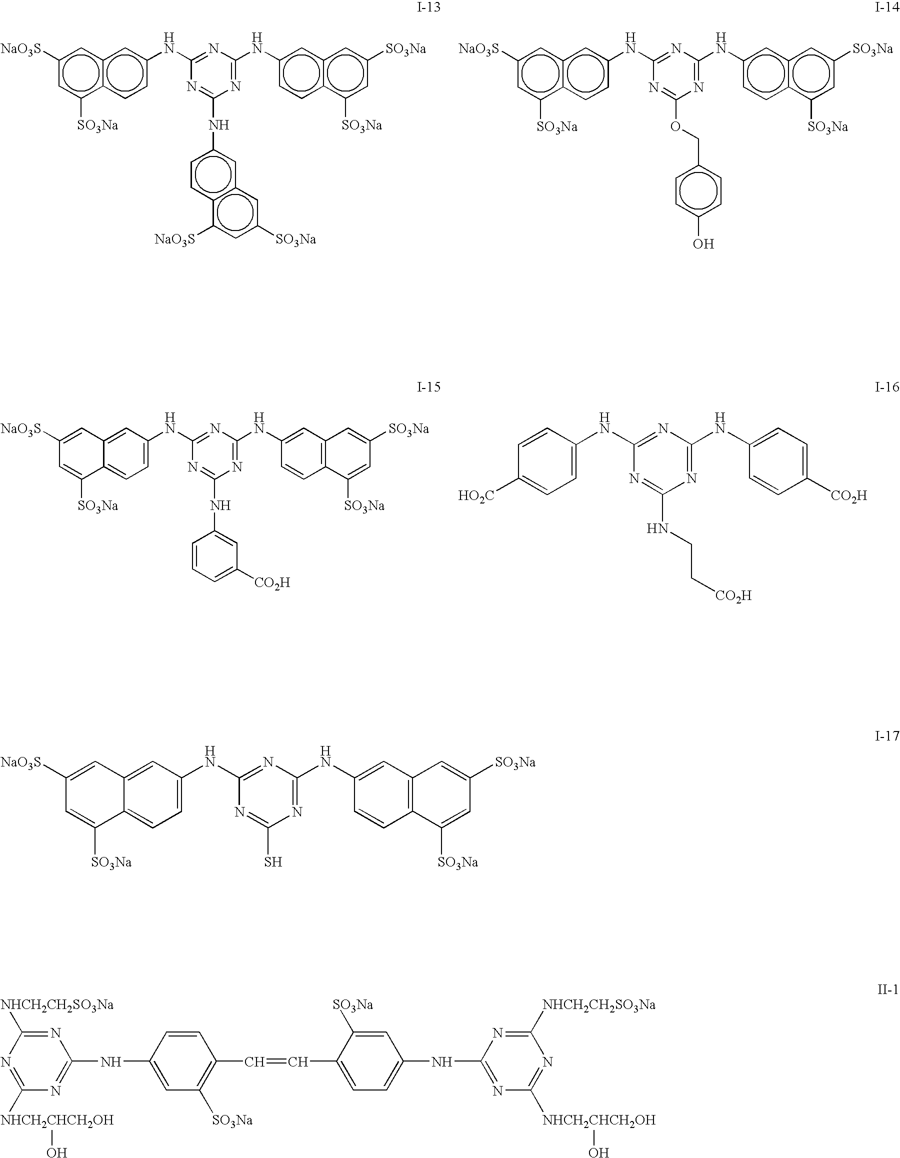

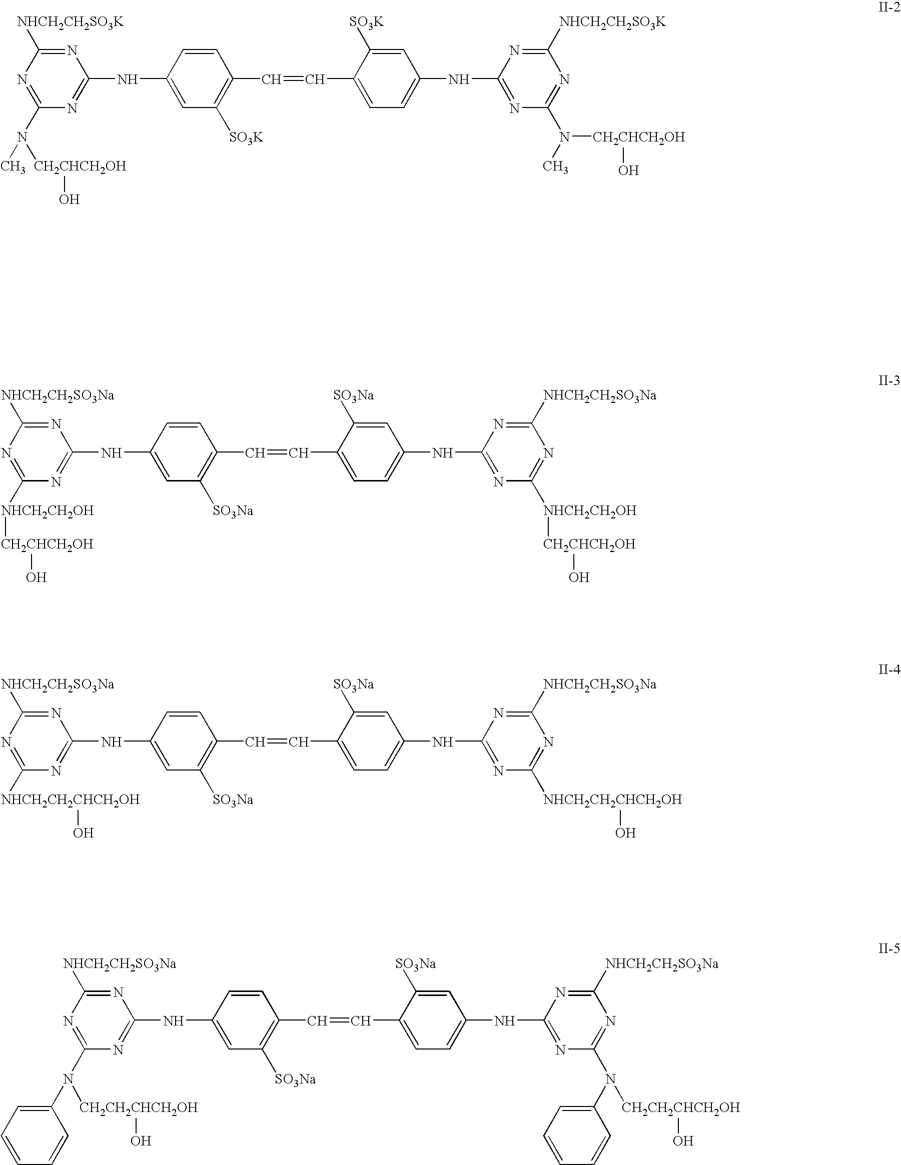

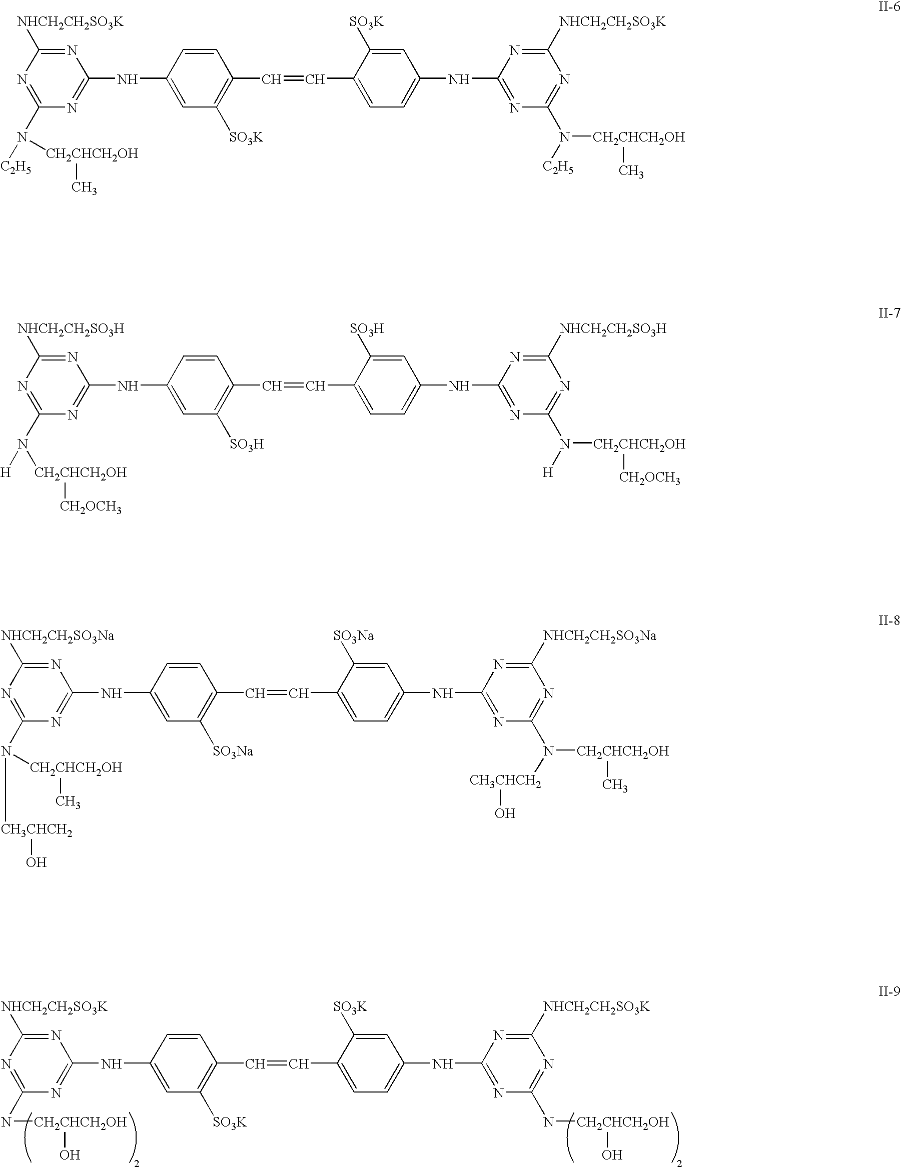

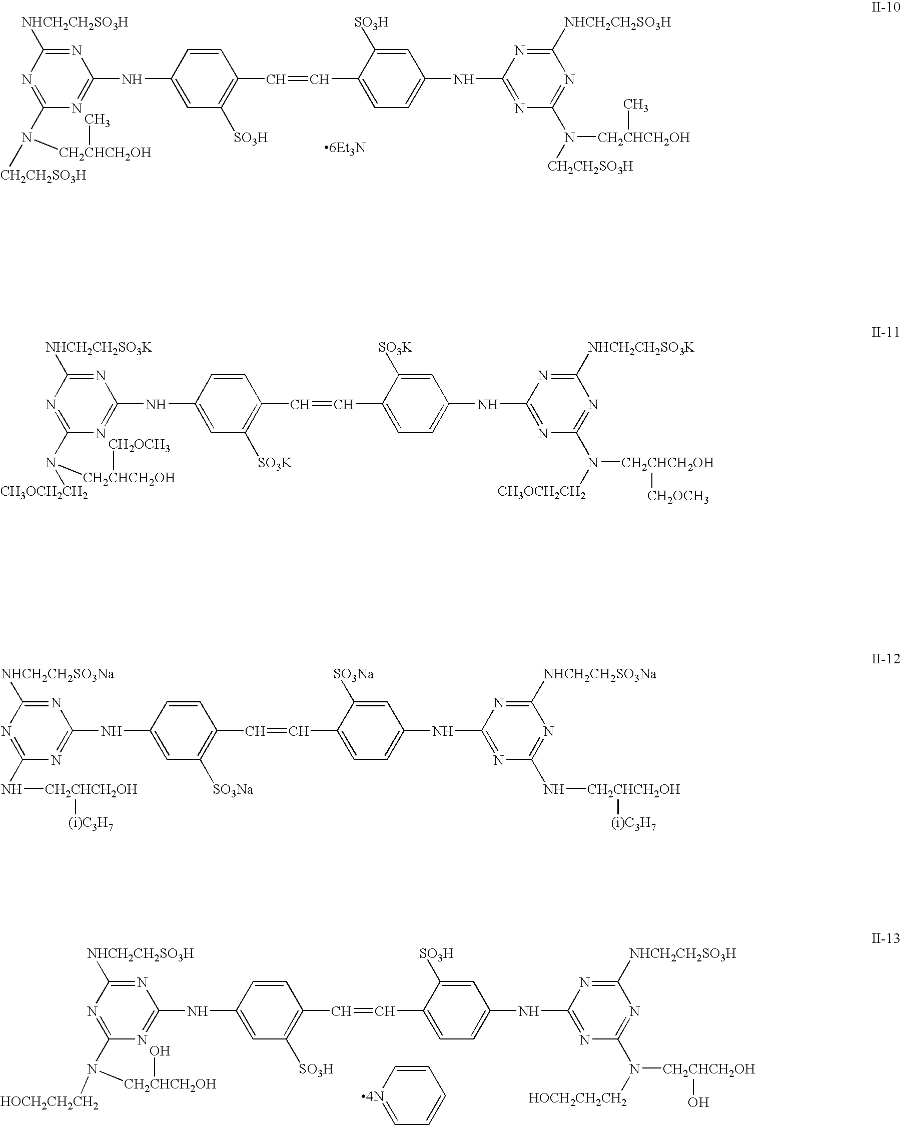

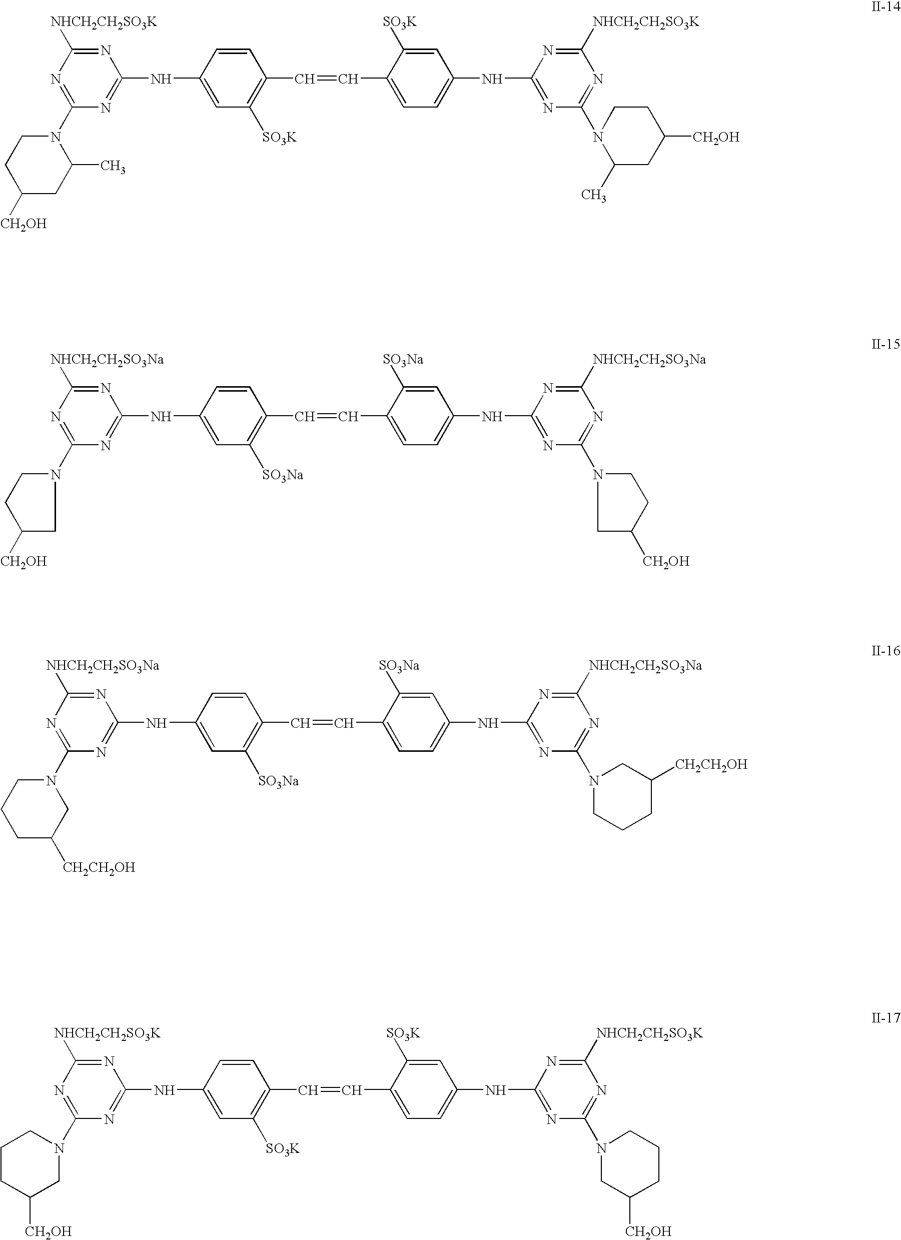

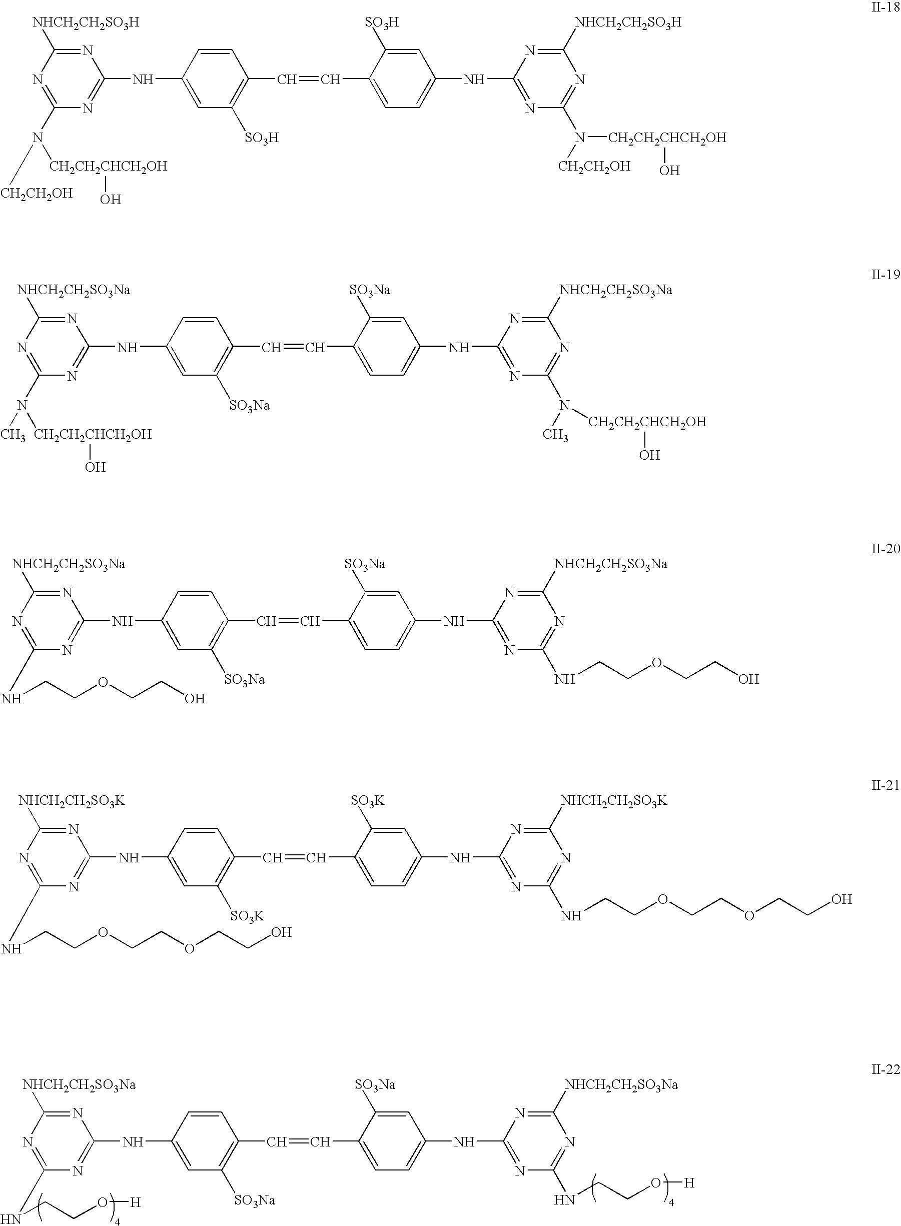

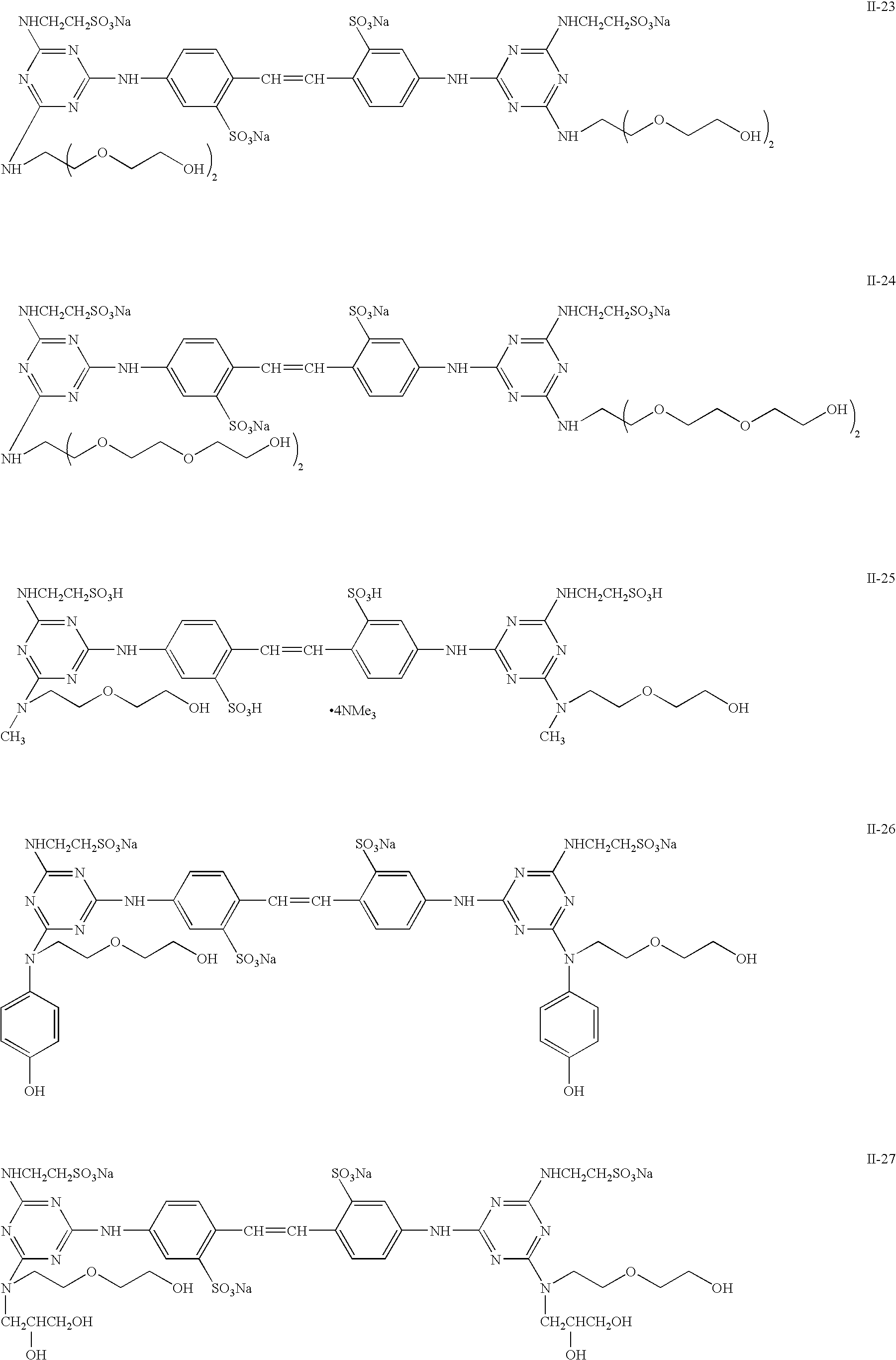

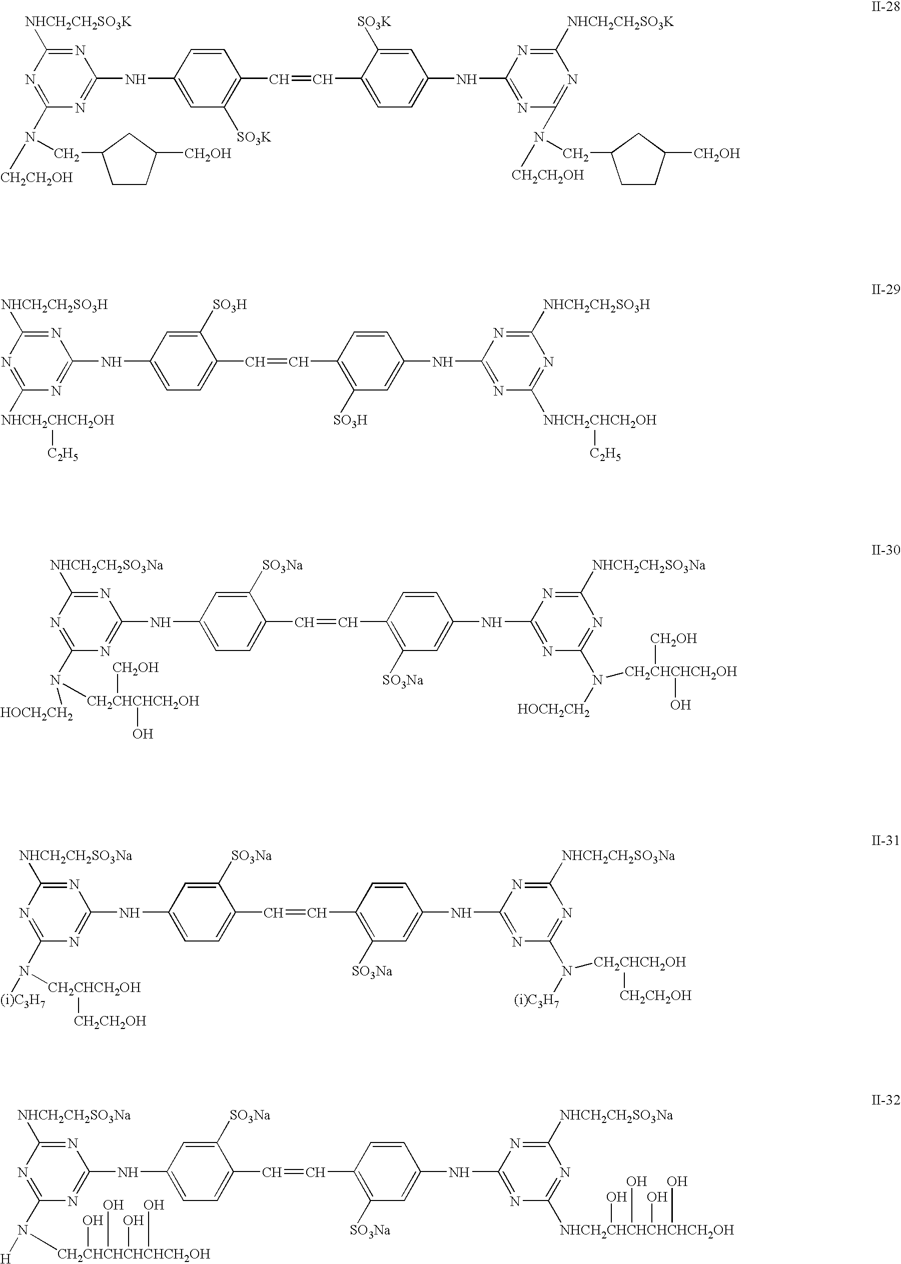

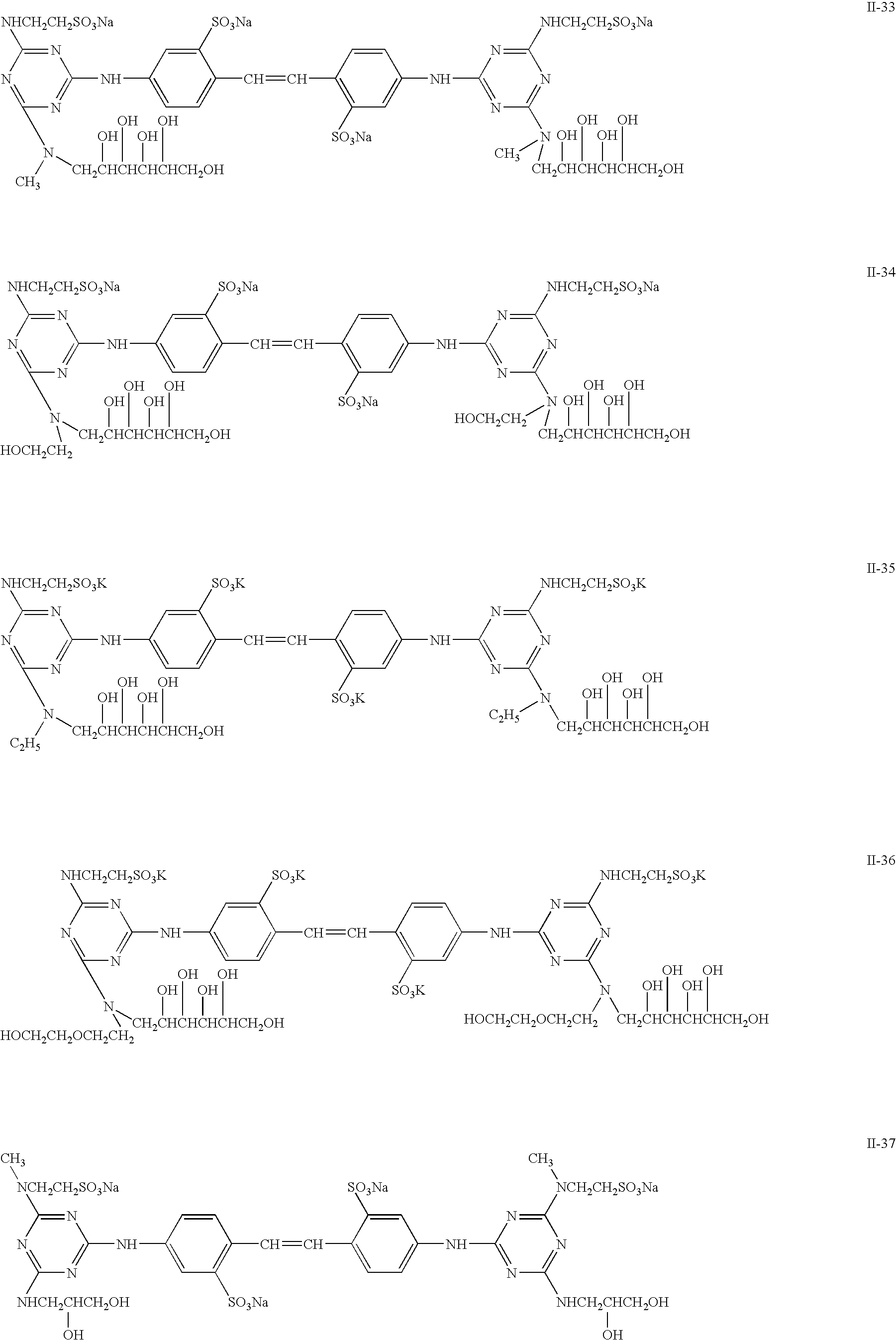

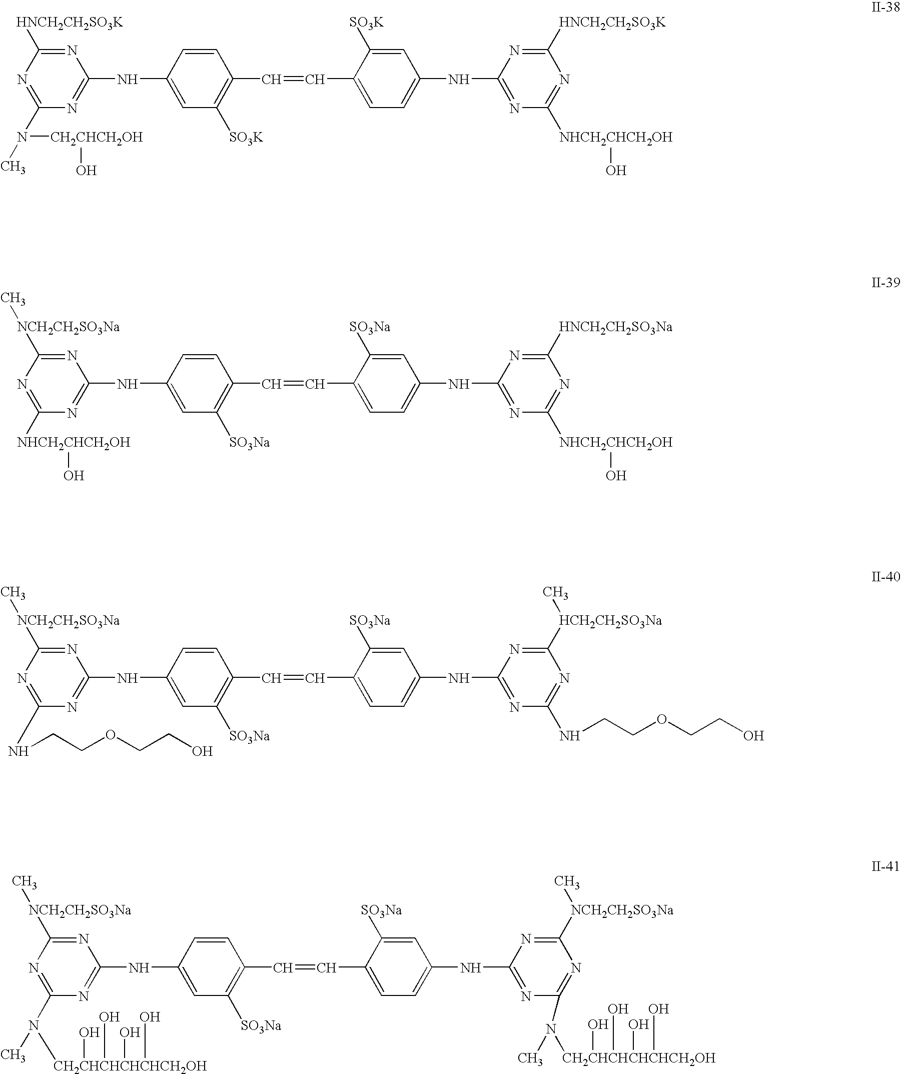

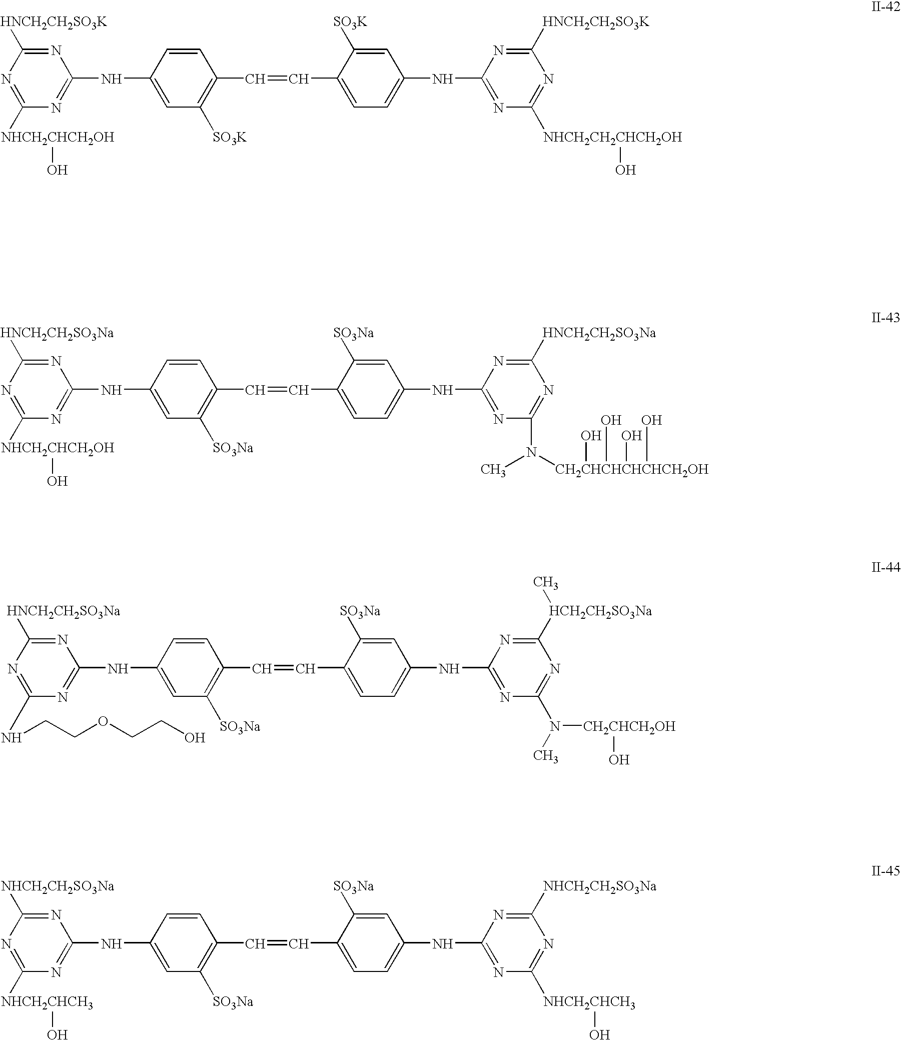

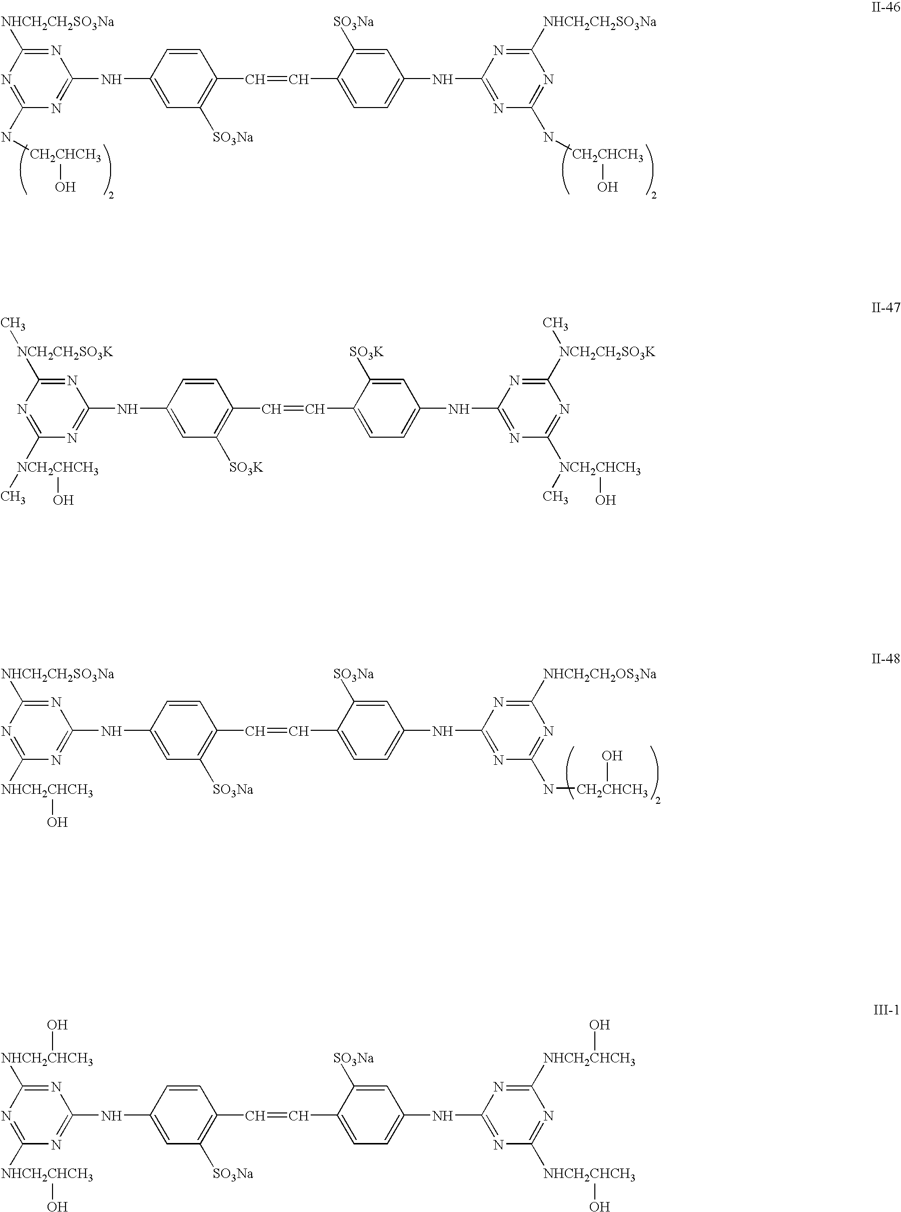

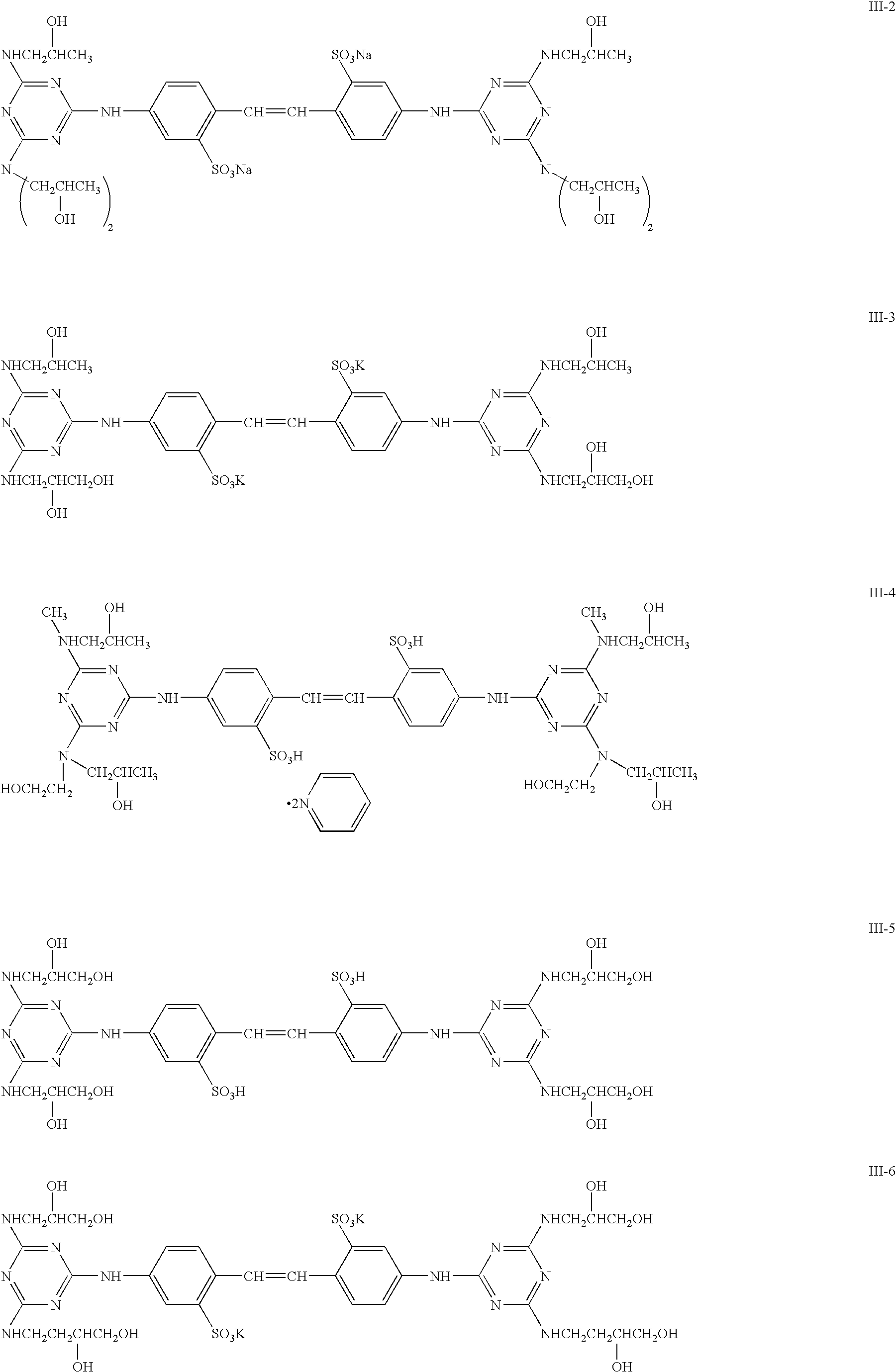

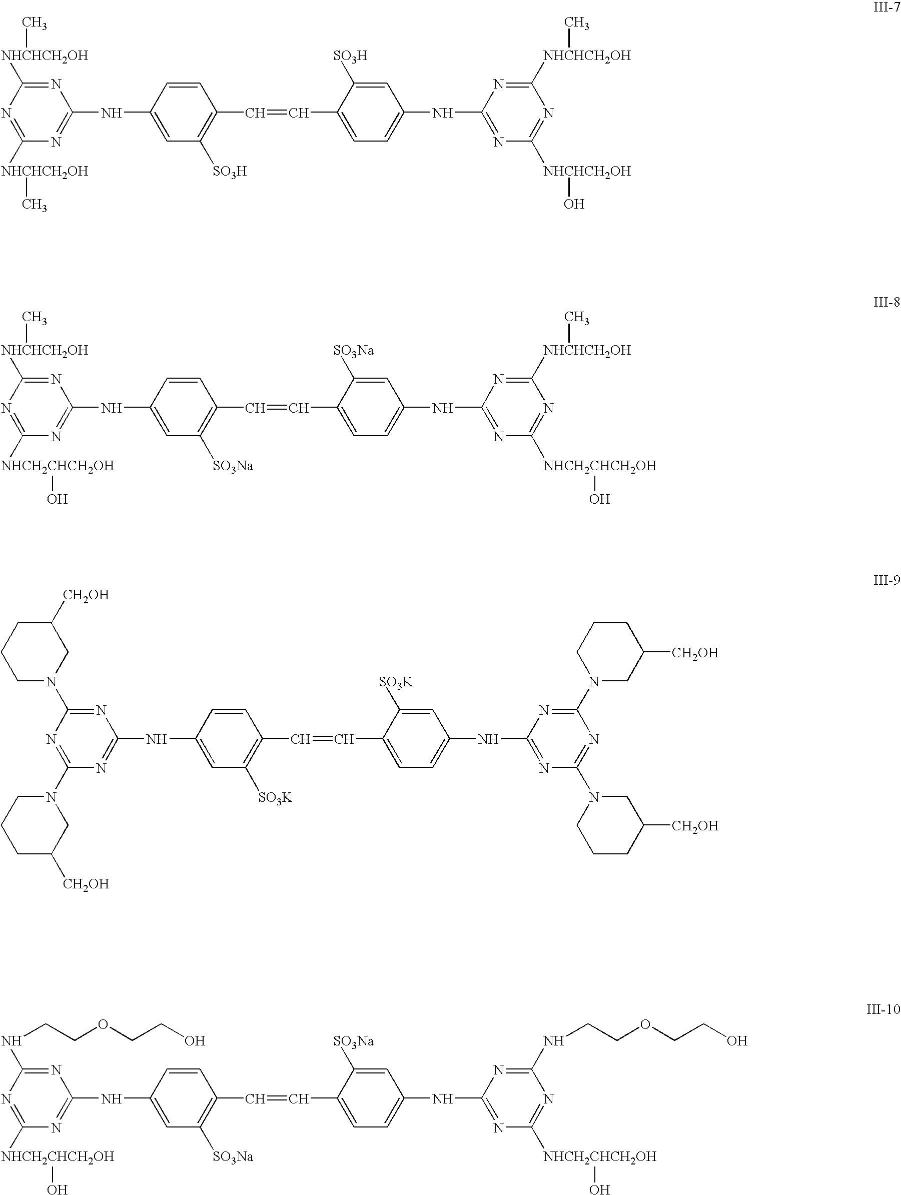

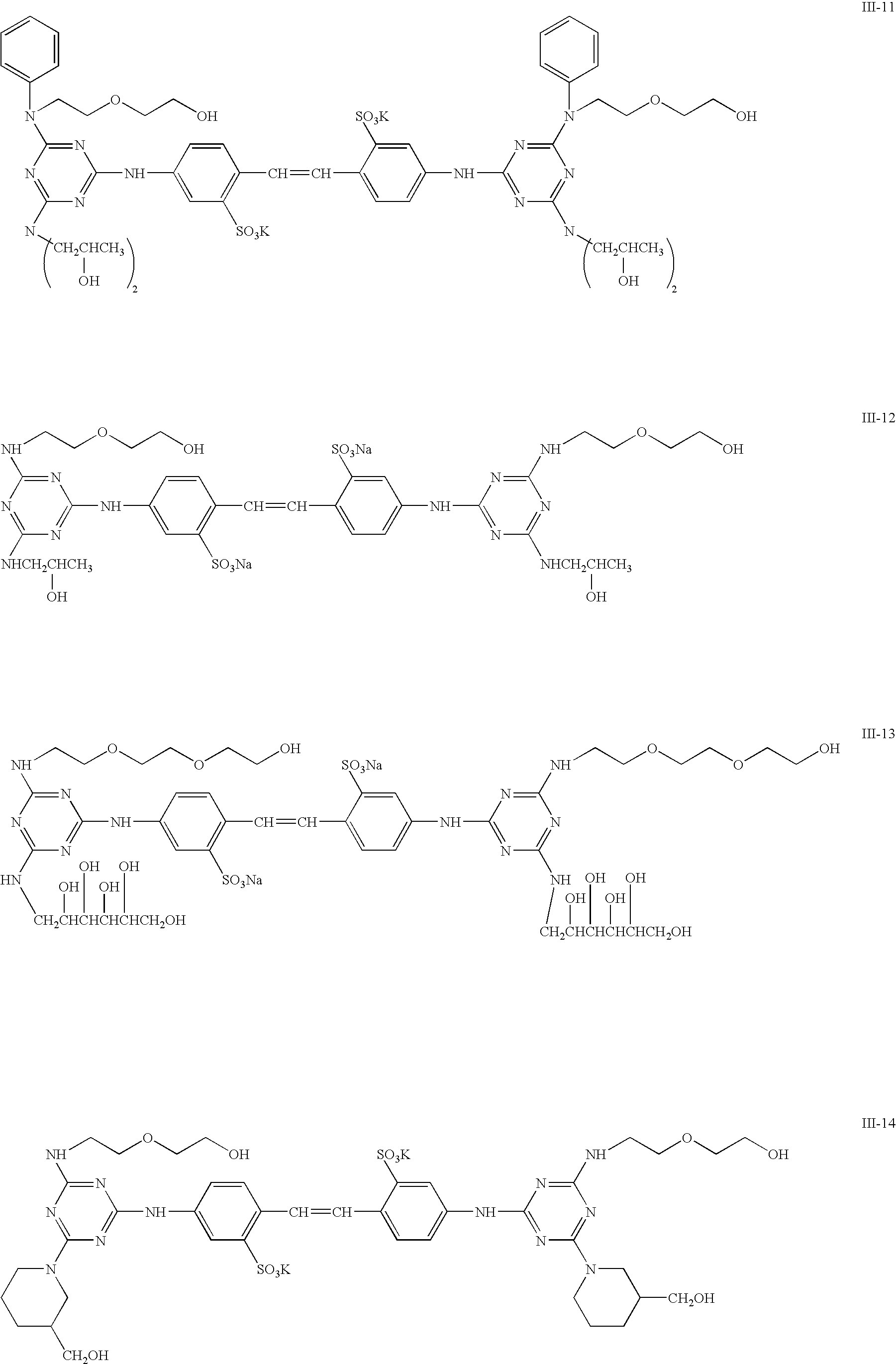

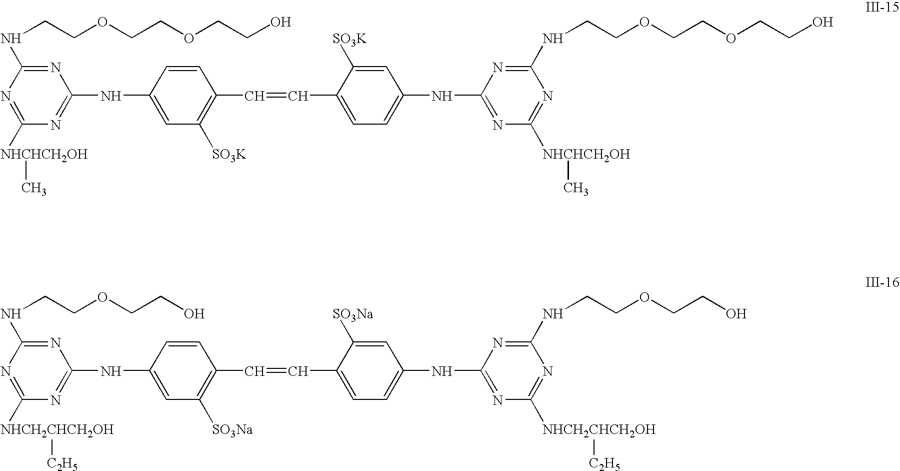

Of the foregoing compounds, compounds I-1 through I-17 are specifically preferred in terms of an improvement of edge staining. The compound represented by the foregoing formula (I), (II) or (III) is contained preferably in an amount of 0.05 to 10 mmol, and more preferably 0.5 to 5 mmol per liter of a concentrated bleach-fixer composition.

The concentrated bleach-fixed composition relating to this invention preferably contains buffer agents. A buffer agent is selected according to an intended pH value and preferred buffer compounds include acetic acid and a compound represented by the following formula (2):

R(COOM)₂ formula (2)

wherein R is a divalent group or a direct bond; M is a hydrogen atom, alkali metal atom, or ammonium group. The divalent group represented by R is preferably an alkylene group, alkenylene group, alkyleneoxyalkylene group, alkylenethioalkylene group, cycloalkylene group and phenylene group. The alkylene group and alkenylene group preferably have 1 to 6 carbon atoms, which may be substituted by a hydroxy group or carboxyl group. An alkylene group constituting the alkyleneoxyalkylene group or alkylenethioalkylene group may be substituted by one or two alkyl group having 1 to 4 carbon atoms (preferably 1 to 3 carbon atoms). The cycloalkylene group (having 3 to 7 carbon atoms) or phenylene group may be substituted by one or two alkyl groups having 1 to 3 carbon atoms, hydroxyl group or carboxyl group.

Specific examples of dicarboxylic acid compound represented by the foregoing formula (2) include glycolic acid, citric acid, tartaric acid, maleic acid, and succinic acid but compounds represented by formula (2) are not limited to the foregoing specific compounds. These compounds may be used in combination. A buffer compound is used preferably in an amount of 0.005 to 4.0 mol, and more preferably 0.05 to 1.5 mol per liter of concentrated bleach-fixer composition.

Fixing agents usable in the concentrated bleach-fixer composition include commonly known fixing agents, for example, alkali metal or ammonium thiosulfate salts, such as sodium thiosulfate and ammonium thiosulfate. Of thiosulfates, ammonium thiosulfate is preferred in terms of solubility. A fixing agent is used preferably in an amount of 0.5 to 4 mol, and more preferably 0.5 to 3.0 mol per liter of concentrated bleach-fixer composition.

The bleach-fixer composition relating to this invention may secondarily other silver halide solvents. Such silver halide solvents secondarily usable in this invention are water-soluble compounds, including, for example, thiocyanates such as sodium thiocyanate and ammonium thiocyanate, thioether compounds such as ethylenebisthioglycolic acid and 3,6-dithia-1,8-octanediol, thioureas such as thiourea and ethylenethiourea. These compounds may be used alone or in combination. There is also usable a specified bleach-fixer composition composed of the combination of a fixing agent described in JP-A No. 55-155354 and a large amount of a halide salt such as potassium iodide.

The bleach-fixer composition relating to this invention may further contain a compound promoting desilvering to achieve shortening the processing time and enhancement of desilvering ability. Compounds suitable for such a purpose include, for example, 1,2,4-triazolium-3-sulfide type mesoion compounds (e.g., 1,4,5-trimethyl-1,2,4-triazolium-3-sulfide), as described in JP-A No. 8-137070; RSO₂M type sulfonic acids (in which R represents alkyl, cycloalkyl, alkenyl, aralkyl and aryl; M represents hydrogen, alkali metal, or ammonium, e.g., phenylsulfinic acid), as described in JP-A No. 8-292510; and 3-mercapto-1,2,4-triazole type compound (e.g., 3-mercapto-1,2,4-triazole-1-methylsulfonic acid), as described in JP-A No. 9-5964. These compounds may be used alone or in combination and are used in amount of 0.001 to 0.1 mol per liter.

The bleach-fixer composition relating to this invention may contain a silver salt forming compound to prevent silver sludge. Compounds suitable for such a purpose include, for example, N-amino-substituted or N-alkoxy-substituted guanidine derivatives (which may be substituted by an alkyl group), e.g., N-(di-n-butylaminopropyl)guanidine, N-(di-n-propylaminoethyl)guanidine, as described in JP-A No. 8-204980; 2-mercaptoazole derivatives and 2-mercaptopyrimidine derivatives, e.g., 2-mercapto-5-acetoamidothiadiazole, 2-mercapto-4-methyl-5-amino-pyridine, as described in JP-A No. 9-211820. These compounds may be used alone or in combination and are used in amount of 0.001 to 0.1 mol per liter.

Next, there will be described a concentration factor of the bleach-fixer composition relating to this invention. A concentration factor is usually used as a practical measure indication an extent of concentration of a concentrated liquid processing composition. The concentration factor can be represented by a volume ratio of a processing solution obtained by diluting a processing composition with water to use as an intended working solution to the original processing composition. Accordingly, the concentration factor varied depending on a concentration of working solution, even if having the same processing composition.

Unless otherwise noted, a working solution used as a standard of the concentration factor is a bleach-fixer solution containing 0.18 mol/l of iron ions of a bleaching agent (a standard concentration). The concentration factor is represented by a dilution ratio to prepare a bleach-fixer solution having the standard concentration. The concentration factor of the concentrated bleach-fixer composition relating to this invention is preferably 1.0 to 5.0, and more preferably 1.2 to 3.0.

The concentrated bleach-fixer composition relating to this invention preferably exhibits a pH of 3 to 8, and more preferably 4 to 7. A lower pH enhances bleaching ability but accelerates deterioration of solution and leuco dye formation and a higher pH retards bleaching. The pH can be adjusted by optionally using hydrochloric acid, sulfuric acid, nitric acid, bicarbonates, ammonia, potassium hydroxide, sodium hydroxide, sodium carbonate, and potassium carbonate.

The concentrated bleach-fixer composition may contain brightening agents, defoaming agents, surfactants, polyvinyl pyrrolidone and organic solvents such as methanol.

The concentrated bleach-fixer composition may contain a sulfite ion releasing compounds, as a preservative, such as sulfites (e.g., sodium sulfite, potassium sulfite, ammonium sulfite), bisulfites (e.g., ammonium bisulfite, sodium bisulfite, potassium bisulfite) and metasulfites (potassiummetasulfite, sodium metasulfite, ammonium metasulfite), and arylsulfinic acids described above, such as p\hat{ }toluenesulfinic acid and m-carboxybenzenesulfinic acid. The content of these compounds, which is represented by equivalent converted to sulfite ion or sulfinic acid ion, is preferably 0.02 to 0.8 mol/l. The concentrated bleach-fixer composition may further contain ascorbic acid, or a carbonyl bisulfite adduct or other carbonyl compounds, as a preservative. There may be incorporated a buffer, chelating agent, defoaming agent and anti-fungal agent.

A concentrated bleach-fixer composition relating to this invention preferably contains a nitrate salt. Specifically, alkali and/or ammonium nitrate salts are preferably used, in which a sulfite and aminopolycarboxylic acid iron complex are superior in dissolution stability and storage stability, resulting in effects of this invention without causing decarboxylation. A nitrate is incorporated preferably in an amount of 5 to 10 mol %, based on aminopolycarboxylic acid iron complex.

The concentrated color developer composition of the invention is preferably allowed to be included in a container. Material used for such a container may be any one such as paper or plastic and preferably is plastic material exhibiting an oxygen permeability of not more than 50 ml/(m²·dya·atm), more preferably not more than 20 ml/(m²·dya·atm), and still more preferably not more than 5 ml/(m²·dya·atm). The oxygen permeability can be determined in the conventional manner, for example, in accordance with the method as defined in JIS 1707.

Examples of such plastic material used for a container include the following groups:

A. polyolefin type resin

B. ethylene-vinyl acetate copolymer type resin

C. ethylene-vinyl alcohol copolymer type resin

D. polyamide type resin

E. ceramics

F. acrylonitrile type resin

G. polyethylene terephthalate type resin

H. polyvinilidene halide type resin

I. polyvinyl halide type resin

Of polyolefin type resin, polyethylene is preferred and any one of linear low density polyethylene (also denoted as LLDPE), intermediate density polyethylene MDPE) and high density polyethylene (HDPE) is usable in this invention, and HDPE, which has a density of 0.941 to 0.969 is preferred in terms of moisture permeability and strength. Preferred LDPE, which has a density of 0.910 to 0.925, can be synthesized through high pressure polymerization. HDPE having the foregoing density is preferred for use for containers used in this invention, and one having a melt index (which is determined at an extrusion pressure of 2.16 kg and a temperature of 190° C., as defined in ASTM D1238) of 0.3 to 7.0 g/10 min. (preferably 0.3 to 5.0 g/10 min) is further preferred. HDPE falling within the foregoing range is stable as a container of the concentrated bleach-fixer composition. The thickness of a container, depending on material is preferably 0.1 to 2.0 mm, more preferably 0.3 to 1.5 mm, and still more preferably 0.4 to 1.0 mm.

Of polyamide type resin, nylon is preferred in terms of sticking strength and anti-pinhole. The thickness thereof is preferably 3 to 50 μm, and more preferably 5 to 30 μm. Stretched nylon is specifically preferred for the object of the invention. Ceramics are inorganic material which is mainly comprised of silicon oxide, and may be coated in vacuo with polyethylene or polyethylene terephthalate. Specific examples thereof include GL type (ceramic deposit film, available from TOPPAN PRINTING CO. LTD.).

Examples of ethylene-vinyl alcohol copolymer resin include KURARAY EVERL FILM (EF-XL, EF-F, EF-E, available from KURARAY CO., LTD.). Halogens of polyvinylidene halide type resin and polyvinyl halide type resin are, for example, chlorine, fluorine and bromine. Specific example include polyvinylidene chloride, polyvinyl chloride, polyvinylidene flioride, and polyvinyl fluoride.

Generation of toxic gas in burning work is not preferable, so that of the foregoing resins, groups A to G are preferred in the invention and A to F are specifically preferred.

The resin usable in the invention can be employed by selecting resins satisfying conditions of the invention from those described in “Plastic Film” (Gisaku Takahashi, Nikkan-Kogyo Shinbun, Dec. 20, 1976, enlarged edition).

These materials may be singly molded or at least two kinds of materials may be laminated in a film form and used as a multi-layer film. The container may form any shape, including bottle type and pillow type. In cases where using multi-layer film for the container, the layer arrangement thereof are, for example, as follows:

(1) LLDPE (linear low density polyethylene/Ny (nylon)/PET (polyethyleneterephthalate)

(2) LLDPE/Ny/EVOH (EVERL)/Ny/ONy (stretched nylon)

(3) LLDPE/EVA (ethylene-vinyl acetate copolymer)/Ny

(4) LLDPE/S·PE (sand polyethylene)/HDPE (high density polyethylene)/Ny/EVOH/Ny/PET

(5) LLDPE/KOH (vinylide chloride coat nylon)

(6) LLDPE/GLPET (ceramic coating polyethyleneterephthalate)

(7) PE (polyethylene)/EVOH/OPP (stretched polypropylene

(8) LDPE (low density polyethylene)/EVOH/PET

(9) LDPE/EVOH/ONy

(10) PE/KPE (vinylidene chloride polyethylene polyester)

(11) PE/Ny

(12) PE/EVOH/Ny

(13) PE/EVOH/KPE

(14) PE/EVOH/KPET (vinylidene chloride coat PET)

(15) LDPE/EVOH/KPET

(16) EVA (ethylene-vinyl acetate copolymer)/Ny

(17) EVA/ONy

(18) EVA/EVOH/ONy

(19) LDPE/AN (acrylonitrile)

(20) LLDPE/S·PE/LLDPE/Ny/EVOH/Ny/ONy

(21) LLDPE/S·PE/HDPE/S·PE/LLDPE/Ny/EVOH/Ny/PET

(22) LLDPE/S·PE/LLDPE/Ny/EVOH/Ny/ONy

(23) LLDPE/S·PE/LLDPE/Ny/EVOH/Ny/PET.

Methods for preparing multiplayer film are not specifically limited, including laminating film with film using adhesive, laminating films with fused resin, extruding two or more resins from slits and so-called co-extrusion, and film lamination methods generally used may be employed alone or in combination.

The replenishing rate of a bleach-fixing composition (processing solution) prepared using the concentrated bleach-fixer composition according to this invention is preferably 20 to 250 ml, and more preferably 30 to 200 ml per m² of photographic material processed. The bleach-fixing time is usually 10 sec. to 6 min. 30 sec. (preferably 30 sec. to 4 min. 30 sec. for color negative film and color reversal film, and 10 sec. to 1 min. for color paper. The processing temperature 25 to 60° C. (preferably 30 to 50° C.) for color negative film, color reversal film and color paper.

Color processing used in this invention comprises the steps of color developing, desilvering, washing or stabilizing and stabilization. In the color developing step, a color developing solution and a developer replenishing solution are prepared from a color developer composition. A color developing agent is preferably an aromatic primary amine color developing agent, specifically p-phenylenediamine derivatives. Representative examples thereof are shown below but are not limited to these examples:

1) N,N-diethyl-p-phenylenediamine

2) 4-amino-N,N-diethyl-p-phenylenediamine

3) 4-amino-N-(β-hydroxyethyl)-N-methylaniline

4) 4-amino-N-ethyl-N-(β-hydroxyethyl)aniline

5) 4-amino-N-ethyl-N-(-hydroxyethyl)-3-methylaniline

6) 4-amino-N-ethyl-N-(3-hydroxypropyl)-3-methylaniline

7) 4-amino-N-ethyl-N-(3-hydroxybutyl)-3-methylaniline

8) 4-amino-N-ethyl-N-(β-methanesulfonamidoethyl)-3-methylaniline

9) 4-amino-N,N-diethyl-3-(β-methoxyethyl)-3-methylaniline

10) 4-amino-N-ethyl-N-(-methoxyethyl)-3-methylaniline

11) 4-amino-N-(-ethoxyethyl)-N-ethyl-3-methylaniline

12) 4-amino-N-(3-carbamoylpropyl)-N-n-propyl-3-methylaniline

13) 4-amino-N-(4-carbamoylbutyl)-N-n-propyl-3-methylaniline.

Of the foregoing p-phenylenediamine derivatives, preferred developing agents are compounds 5), 6), 7), 8) and 12), and compounds 5) and 8) are more frequently used.

Solids of the foregoing p-phenylenediamine derivatives are in the form of a salt, such as a sulfate, hydrochloride, sulfite, naphthalenesulfonate or p-toluenesulfonate. A concentrated color developer composition is mixed with water in a prescribed ratio and made up in the form of a developing replenisher working solution. The concentration of an aromatic primary amine developing agent is preferably 2 to 200 mmol, more preferably 12 to 200 mmol, and still more preferably 12 to 150 mmol per liter of developer solution.

A color developer solution used in this invention often contains a hydroxylamine or its derivatives, or a N-alkylhydroxylamine or its derivatives. Preferred preservatives used in a color developer solution include, for example, alkanolamines, hydroxylamine derivatives, hydroxamic acids, hydrazides, phenols, α-hydroxyketones, α-aminoketones, saccharides, polyethyleneimines, monoamines, quaternary ammonium salts, nitroxy radicals, alcohols, oximes, diamide compounds and condensed cyclic amines. These compounds are described in JP-A Nos. 63-4235, 63-30845, 63-21647, 63-44655, 63-53551, 63-43140, 63-56654, 63-58346, 63-43138, 63-146041, 63-44657, 63-44656; U.S. Pat. Nos. 3,615,503, 2,494,903; JP-A No. 52-143020; JP-B No. 48-30496 (hereinafter, the term, JP-B refers to Japanese Patent Publication). When constructing a processing composition, these preservatives are included in a separate part from the developing agent containing part.

A color developer solution contains chloride ions usually in an amount of 3.5×10⁻² to 1.5×10⁻¹ mol/l. Chloride ions are usually released as a by-product to a developer solution so that chloride ions are often not needed to be added to a replenisher solution. A bromide ion content is the same the chloride ion content. The bromide ion content of a color developer solution is usually 1 to 5×10⁻³ mol/l for photographic material for camera use and not more than 1×10⁻³ mol/l for photographic print material.

In cases where processed photographic material is color print paper, whiteness of the background is an essential image characteristic, so that stilbene type brightening agents, specifically di(triazylamino)stilbene type brighteners and 4,4′-diamino-2,2′-disulfostilbene type brighteners are often added to a color developer solution. Stilbene type brightening agents may be added to a desilvering solution or photographic material as well as color developer solution. The content is preferably 1×10⁻⁴ to 5×10⁻² mol/l, and more preferably 2×10⁻⁴ to 1×10⁻² mol/l.

A color developer solution or color developer replenishing solution exhibits a pH of 9.5 or more, and preferably 10.0 to 12.5. The use of various buffers is preferred to stably maintain the pH. Examples of buffers usable in this invention include a carbonate, phosphate, borate, tetraborate, hydroxybenzoate, glycyl salt, N,N-dimetylglycine salt, leucine salt, norleucine salt, guanine slt, 3,4-dihydroxyphenylalanine salt, alanine salt, aminobutyric acid, 2-amino-2-methyl-1,3-propanediol salt, valine salt, proline salt, trishydroxyaminomethane salt, and lycine salt. A buffer is used preferably in an amount of 0.01 to 2 mol, and more preferably 0.1 to 0.5 mol per liter of color developer replenishing solution prepared by diluting a concentrated color developer composition.

A concentrated color developer composition used in this invention may contain other ingredients, such as various kinds of chelating agents, which are usable for preventing precipitation of calcium or magnesium or enhancing stability of color developer solution. Examples of chelating agents include nitrilotriacetic acid, diethylenetriaminepentaacetic acid, Ethylenediaminetetraacetic acid, N,N,N-trimethylenephosphonic acid, ethylenediamine-N,N,N′,N′-tetramethylenesulfonic acid, ethylenediamine-N,N-disuccinic acid, N,N-di(carboxylate)-L-asparagic acid, β-alaninedisuccininc acid, trans-siloxanediaminetetraacetic acid, 1,2-diaminopropanetetraacetic acid, glycol-ether-diaminetetraacetic acid, ethylenediamineorthohydroxyphenylacetic acid, 2-phosphonobutane-1,2,4-tricarboxylic acid, 1-hydroxyethylidene-1,1-diphosphonic acid, N,N′-bis(2-hydroxybenzyl)ethylenediamine-N,N′-diacetic acid, and 1,2-dihydroxybenzene-4,6-disulfonic acid. These chelating agents may optionally used in combination. A chelating agent is used in an amount sufficient for sequestering metal ions contained in color developer solution, for example, 0.1 to 10 g per liter.

A color developer solution may optionally be added with a development accelerator. Development accelerators include, for example, commonly known thioether compounds, p-phenylenediamine type compounds, quaternary ammonium salt compounds, amine type compounds, polyalkyleneoxides, 1-phenyl-3-pyrazolidones, and imidazole compounds.

A color developer solution may optionally contain antifogging agents. Alkali metal halides and organic antifoggants are usable as an antifogging agent. Organic antifoggants include nitrogen-containing heterocyclic compounds, for example, benzotriazole, 6-nitrobenzimidazole, 5-nitroisoindazole, 5-methylbenzotriazole, 5-nitrobenzotriazole, 5-chloro-benzotriazole, 2-thiazolylbenzimidazole, 2-thiazolylmethylbenzimidazole, indazole, and hydroxyazaindolidine and adenine.

There may be incorporated various kinds of surfactants including polyalkylene glycols, alkylsulfonic acid, arylsulfonic acid, aliphatic sulfonic acid, aromatic carboxylic acid.

There are described as above a concentrated color developer composition and a color developer solution and color developer replenishing solution prepared from the color developer composition, which are used in combination with the concentrated bleach-fixer composition relating to this invention.

The color developing temperature is preferably 30 to 55° C., more preferably 35 to 55° C., and still more preferably 38 to 45° C. for color paper. The developing time is preferably 5 to 90 sec., and more preferably 15 to 60 sec. The replenishing rate is preferably 15 to 600 ml, and more preferably 30 to 180 ml per m² of photographic material.

The color developing temperature is preferably 20 to 55° C., more preferably 30 to 55° C., and still more preferably 38 to 45° C. for color negative film. The developing time is preferably 20 sec to 6 min., and more preferably 30 to 200 sec. The replenishing rate is preferably 100 to 800 ml, and more preferably 200 to 500 ml per m² of photographic material.

The concentrated bleach-fixer composition relating to this invention is used in the desilvering step in the process of color processing. Constitution of the desilvering step may take various forms, as shown below. Using the concentrated bleach-fixer composition, a bleach-fixer solution is prepared and added to a bleach-fixing bath. The desilvering step is usually constituted of this step, for example, the following bleaching or fixing step may be further added:

Typical desilvering sequence is as follows:

(1) bleach-fixing,

(2) bleaching and bleach-fixing,

(3) bleaching, bleach-fixing and fixing,

(4) fixing and bleach-fixing,

(5) bleach-fixing and fixing.

Each of the bleaching, bleach-fixing and fixing steps may appropriately be divided into plural baths and a cascade system may be applicable thereto. There have been described concentrated bleach-fixer compositions and the composition of a processing solution prepared from the bleach-fixer composition, and the processing temperature and time of the bleach-fixing step. This step will be further described.

When continuously running the process over a long period of time using a bleach-fixer solution (processing solution) used in this invention, it is preferred to conduct aeration to stably maintain high photographic performance. Aeration can be carried out by commonly known means, such as air blowing or air inhalation employing an ejector. Air blowing is carried out preferably through an aeration tube having fine pores to eject air into the liquid. Such an aeration tube is broadly employed, for example, in aeration tank of activated sludge processing. However, excessive aeration, which causes unnecessary oxidation of processing solution must be avoided. To aeration is applicable items described in Z-121, Using Process C-41, 3rd edition (1982, published by Eastman Kodak), page BL-1 to BL-2.

Bleach-fixing is conducted preferably with stirring in accordance with the procedure described in JP-A No. 3-33847, page 8, right upper column line 6 to left lower column, line 2. Reinforced stirring is preferable in the desilvering process. Specific methods for reinforced stirring include, for example, a method of allowing jet flow to impinge onto the emulsion surface of photographic material, as described in JP-A No. 62-183460; a method of enhancing stirring efficiency by means of rotation, as described in JP-No. 62-183461; a method in which photographic material is moved, while bringing a wiper blade provided in the liquid into contact with the emulsion-side surface of the photographic material to cause turbulent flow near the surface to enhance a stirring effect; and a method of increasing circulation flow of the whole processing solution. Such a means for enhancing stirring is effective for any one of the bleaching solution, bleach-fixing solution and fixing solution. Enhancement of stirring accelerates supplying a bleaching agent and fixing agent to the interior of an emulsion layer, resulting in an enhanced desilvering speed. The foregoing means for enhancing stirring is also effective in cases when using a bleach-promoting agent, leading to a markedly increased promotion effect or dissolving the fixation-inhibiting action of a bleach-promoting agent.

Automatic processors used in this invention are preferably provided with a means for transporting photographic material, described in JP-A Nos. 60-191257, 60-191258 and 60-191259. As described in JP-A No. 60-191257, such a transporting means markedly reduces carry-in of from a front bath to a rear bath, effectively preventing deterioration of performance of a processing solution. Such an effect is specifically effective in shortening the processing time in the respective processing steps and reducing the replenishing amount of the respective processing solutions.

After completion of a desilvering treatment such as fixing or bleach-fixing, any one or both of a washing and a stabilizing treatment as an alternative for washing is generally conducted. In the process of washing or washing-alternate stabilizing treatment (hereinafter, also denoted as a washing treatment), the washing water amount can be broadly set according to characteristics of photographic material (e.g., due to materials used therein, such as a coupler), usage, washing water temperature, the number of washing tanks (the number of stages or stage number) and other varying conditions.

Specifically, the relationship of the number of washing tanks and the amount of washing water in a cascaded counter-current washing system can be determined in accordance with the method described in Journal of the Society of Motion Picture and Television Engineers, vol. 64, page 248-253 (May, 1955). The number of stages in the cascaded counter-current washing system is preferably 3 to 15 stages, and more preferably 3 to 10 stages. Although the cascaded counter-current washing system markedly reduces the washing water amount, the increased retention time of water in a tank results in an increase of bacteria, producing problems that formed floating material adheres onto photographic material. A technique for reducing calcium or magnesium as described in JP-A No. 62-28838 can effectively be employed to overcome the foregoing problems. There are also usable isothiazolone compounds and cyabendazole described in JP-A No. 57-8542, chlorine type bacteriocides such as chlorinated cyanuric acid sodium salt, described in JP-A No. 61-120145, benzotriazole described in JP-A No. 61-267761, copper ion, and bacteriocides described in H. Horiguchi et al. “Bokin-Bobai no Kagaku” (1986, published by Sankyo Shuppan), Eisei-Gijutsu-Kai “Biseibutsu no Genkin, Sakkin, Bobai Gijutsu” (1982, Kogyogijutsukai), Nippon Bokin Bobai Gakkai “Bokin Bobaizai Jiten” (1986).

Washing water may further contain surfactants as a wetting agent or chelating agents, e.g., EDTA as a water softening agent. A stabilizing treatment is feasible subsequent to or without subjecting washing. To a stabilizing solution, compounds having an image stabilizing function may be added, including aldehyde compounds such as formalin, a buffer to adjust a pH suitable for stabilizing dyes and ammonium compounds.

There may further be added aldehydes such as formaldehyde, acetoaldehyde, and pyruvic aldehyde; methylol compounds or hexamethylenetetramine described in U.S. Pat. No. 4,786,583; hexahydrotriazines described in JP-A No. 2-15348; formaldehyde sulfite adduct described in U.S. Pat. No. 4,921,779; and azolylmethylamines described in European Patent Nos. 504609 and 519190. The bacteriocides and fungicides described earlier are also usable to prevent propagation of bacteria and provide antiseptic ability to processed photographic material. There may be added surfactants, brightening agents and hardening agents. Commonly known methods described in JP-A Nos. 57-8543, 58-14834 and 60-220345 are applicable in cases when stabilization is directly conducted without subjecting photographic material to washing. Furthermore, the use of chelating agents such as 1-hydroxyethylidene-1,1-diphosphonic acid and ethylenediaminetetramethylenephosphonic acid, and magnesium or bismuth compounds is a preferred embodiment.

A rinse solution can be alternatively used as a washing solution or stabilizing solution in a washing treatment after desilvering. The washing solution or stabilizing solution exhibits preferably a pH of 4 to 10, and more preferably 5 to 8. The processing time is preferably not more than 120 sec., more preferably 5 to 70 sec., and still more preferably 10 to 55 sec. The processing temperature is usually 20 to 50° C., and preferably 25 to 45° C.

Subsequent to the washing or stabilizer treatment, drying is conducted. Drying can be accelerated by absorbing water using a squeeze roller or cloth to reduce the water content of the imaging layer after being ejected from a washing bath. Raising the drying temperature or changing the form of impingement nozzles to increase a drying wind power can also accelerate drying. Furthermore, adjustment of the blowing angle or removal of exhausted air can also accelerate drying, as described in JP-A No. 3-157650.

### EXAMPLES

The present invention will be further described based on examples but embodiments of the invention are by no means limited to these.

### Example 1

### Preparation of Concentrated Bleach-fixer Composition

Single-part type concentrated bleach-fixer compositions were prepared, as shown below. The prepared compositions were each sealed at a free volume of 20% in a container of packing material exhibiting an oxygen permeability, as shown below, to prepare a single part package of concentrated bleach-fixer composition (kit).

Concentrated Bleach-fixer Composition

| Ammonium sulfite (40 wt/vol %) | 0.58 mol |
|---|---|
| Ammonium thiosulfate (75 wt/vol %) | 1.1 mol |
| Aminopolycarboxylic acid iron(III) | |
| complex, as shown in Table 1 | |
| Aminopolycarboxylic acid iron(II) | |
| complex, as shown in Table 1 | |
| Additive, as shown in Table 1 | |
| pH | 5.5 |

Water was added to make 1 liter and the pH was adjusted with an aqueous ammonia solution or 50% sulfuric acid.

Layered Packing Material (oxygen permeability, ml/m² · day · atm)
[outer side ← → processing solution side]

(a) LDPE 50 μm (2700)
(b) OPP 20 μm/LLDPE 40 μm (1000)
(c) ONy 30 μm/LLDPE 60 μm (25)
(d) K-ONy 15 μm/LLDPE 60 μm (5)
(e) Ny 15 μm/EVOH 12 μm/LLDPE 50 μm (2)
(f) OPP 20 μm/EVOH 20 μm/LLDPE 50 μm (0.4)
LDPE: low density polyethylene
LLDPE: linear low density polyethylene
OPP: stretched polypropylene
ONy: stretched nylon
Ny: nylon
K-ONy: vinylidene chloride coating stretched nylon
EVOH: ethylene-vinylalcohol copolymer resin

The foregoing aminopolycarboxylic acid iron(II) complex was prepared by adding iron(II) sulfate (hexa-hydrate) and an aminopolycarboxylic acid of 1.05 molar times the iron(II) sulfate and dissolving them with stirring.

The concentrated bleach-fixer packages (kit) were stored at room temperature (18 to 22° C.) over a period of 10 months. After aged, the concentrated bleach-fixer compositions were each diluted to 2.0 times with water to prepare a bleach-fixer replenishing solution. Using these replenishing solution, photographic color paper material was continuously processed according to the procedure described below. The bleach-fixer replenishing solution was also used as a tank solution.

### Exposure and Processing

Photographic color paper, Konica Color QA Paper Type A (available from Konica Corp.) was exposed through negative film and processed according to the following processing steps, using automatic processor NPS-808 GOLD (available from Konica Corp.) Processing was run at 0.2R (round) per day until reached 2R. Herein, “2R” means that a bleach-fixer replenishing solution is replenished in an amount of two times the volume of a bleach-fixer tank.

### Processing Step and Condition

| | | | Tank | Replenishing |
|---|---|---|---|---|
| Step | Temperature | Time | volume | Rate |
| Color developing | 39.8° C. | 22 sec | 12.5 l | 80 ml/m² |
| Bleach-fixing | 38.0° C. | 22 sec | 12.3 l | 80 ml/m² |
| Stabilizing 1 | 32.0° C. | 22 sec | 11.8 l | |
| Stabilizing 2 | 32.0° C. | 22 sec | 11.8 l | |
| Stabilizing 3 | 32.0° C. | 22 sec | 11.8 l | 180 ml/m² |
| Drying | 60 to 80° C. | 30 sec | | |

Stabilizing is cascaded counter flow of 3→2→1.

Formulas of color developing solution and stabilizing solution are as follows:

| Color developing | Tank | Replenisher |
|---|---|---|
| solution (per liter) | Solution | Solution |
| Polyethylene glycol #4000 | 15.0 g | 15.0 g |
| Sodium p-toluenesulfonate | 10.0 g | 10.0 g |
| Potassium chloride | 4.0 g | — |
| 4-Amino-3-methyl-N-ethyl-[β-(methane- | 6.0 g | 11.5 g |
| sulfonamido)ethyl]aniline sulfonate | | |
| N,N-bis(sulfoethyl)hydroxylamine | 4.0 g | 8.0 g |
| disodium salt | | |
| Potassium carbonate | 33.0 g | 33.0 g |
| Diethylenetriaminepentaacetic acid | 11.0 g | 11.0 g |
| pH | 10.25 | 12.2 |

Water was added to make 1 liter and the pH was adjusted
with potassium hydroxide or 50% sulfuric acid.

| Stabilizer | Tank and Replenisher |
|---|---|
| solution (per liter) | Solution |
| Trisodium 1-hydroxyethylidene- | 3.0 g |
| 1,1-phosphnate | |
| Ethylenediaminetetraacetic acid | 1.5 g |
| o-Phenylphenol | 0.1 g |
| Chinopal SFP | 0.5 g |
| Sodium sulfite | 0.5 g |
| pH | 8.0 |

Water was added to make 1 liter and the pH was adjusted
with aqueous ammonia solution or 50% sulfuric acid.

### Evaluation

Print Background Whiteness

Before start of running process, wedge-exposed color paper(Konica Color QA Paper Type A7) was processed and the unexposed area was measured with respect to blue density (Dmin-Blue), using X-rite densitometer. Further, After completion of running process, wedge-exposed color paper was processed and the unexposed area was similarly measured with respect to blue density. The difference (ΔD) in unexposed area density between before and after running process was determined, according to the following equation:

ΔD=Dmin-Blue density after completion of running process minus Dmin-Blue density before start of running process.

Stain

Wedge-exposed color paper (Konica Color QA Paper Type A7) was processed at the time when starting running process and the thus processed color paper samples were subjected to accelerated aging under high temperature and high humidity conditions of 70° C. and 90% RH over a period of 7 days. A blue density of unexposed areas (Dmini-Blue) was measured using X-rite densitometer and the difference in minimum density between before and after aging was determined as a measure of staining by aging, according to the following equation:

Stain=(Dmini-Blue before aging) minus (Dmini-Blue after aging)

Results are shown in Table 1.

TABLE 1

| | Container | | | Fe(II) |
|---|---|---|---|---|
| | (Oxygen | | Fe(II) | Ratio |
| Expt. | Permeability, | Fe(III) Complex*¹ | Complex*² | (mol |
| No. | ml/m² · day) | (mol/l) | (mol/l) | %) |
| I-1 | a(2500) | EDTA-FeNH₄(0.18) | EDTA-Fe(0.18) | 50 |
| I-2 | b(1000) | EDTA-FeNH₄(0.18) | EDTA-Fe(0.18) | 50 |
| I-3 | b(1000) | EDTA-FeNH₄(0.144) | EDTA-Fe(0.216) | 60 |
| I-4 | b(1000) | EDTA-FeNH₄(0.108) | EDTA-Fe(0.252) | 70 |
| I-5 | b(1000) | EDTA-FeNH₄(0.072) | EDTA-Fe(0.288) | 80 |
| I-6 | b(1000) | EDTA-FeNH₄(0.072) | EDTA-Fe(0.288) | 100 |
| I-7 | c(25) | EDTA-FeNH₄(0.18) | EDTA-Fe(0.18) | 50 |
| I-8 | d(5) | EDTA-FeNH₄(0.18) | EDTA-Fe(0.18) | 50 |
| I-9 | e(2) | EDTA-FeNH₄(0.18) | EDTA-Fe(0.18) | 50 |
| I-10 | f(0.4) | EDTA-FeNH₄(0.18) | EDTA-Fe(0.18) | 50 |
| I-11 | b(1000) | EDTA-FeNH₄(0.18) | EDTA-Fe(0.18) | 50 |
| I-12 | b(1000) | EDTA-FeNH₄(0.18) | EDTA-Fe(0.18) | 50 |
| I-13 | b(1000) | EDTA-FeNH₄(0.18) | EDTA-Fe(0.18) | 50 |
| I-14 | b(1000) | EDTA-FeNH₄(0.18) | EDTA-Fe(0.18) | 50 |
| I-15 | b(1000) | EDTA-FeNH₄(0.18) | EDTA-Fe(0.18) | 50 |
| I-16 | b(1000) | EDTA-FeNH₄(0.18) | EDTA-Fe(0.18) | 50 |
| I-17 | b(1000) | EDTA-FeNH₄(0.18) | EDTA-Fe(0.18) | 50 |
| I-18 | b(1000) | EDTA-FeNH₄(0.144)/ | EDTA-Fe(0.18) | 50 |
| | | DTPA-FeNH₄(0.036) | | |
| I-19 | b(1000) | EDTA-FeNH₄(0.144)/ | EDTA-Fe(0.18) | 50 |
| | | s,s-EDDS-FeNH₄(0.036) | | |
| I-20 | b(1000) | EDTA-FeNH₄(0.108)/ | EDTA-Fe(0.18) | 50 |
| | | DTPA-FeNH₄(0.072) | | |
| I-21 | b(1000) | EDTA-FeNH₄(0.108)/ | EDTA-Fe(0.18) | 50 |
| | | s,s-EDDS-FeNH₄(0.072) | | |
| I-22 | b(1000) | EDTA-FeNH₄(0.18) | EDTA-Fe(0.18) | 50 |
| I-23 | b(1000) | EDTA-FeNH₄(0.216) | EDTA-Fe(0.144) | 40 |
| I-24 | b(1000) | EDTA-FeNH₄(0.252) | EDTA-Fe(0.108) | 30 |
| I-25 | b(1000) | EDTA-FeNH₄(0.216) | EDTA-Fe(0.144) | 40 |
| I-26 | b(1000) | EDTA-FeNH₄(0.216) | EDTA-Fe(0.144) | 40 |
| I-27 | b(1000) | EDTA-FeNH₄(0.072)/ | EDTA-Fe(0.18) | 50 |
| | | DTPA-FeNH₄(0.108) | | |
| I-28 | b(1000) | EDTA-FeNH₄(0.072)/ | EDTA-Fe(0.18) | 50 |
| | | s,s-EDDS-FeNH₄(0.108) | | |
| I-29 | b(1000) | EDTA-FeNH₄(0.036)/ | EDTA-Fe(0.18) | 50 |
| | | DTPA-FeNH₄(0.144) | | |
| I-30 | b(1000) | EDTA-FeNH₄(0.036)/ | EDTA-Fe(0.18) | 50 |
| | | s,s-EDDS-FeNH₄(0.144) | | |

| | EDTA | | Photographic | |
|---|---|---|---|---|
| Expt. | Ratio | | Quality | |
| No. | (mol %) | Additive (mol %) | Whiteness | Stain |
| I-1 | 100 | Imidazole (0.04) | 0.04 | 0.06 |
| I-2 | 100 | Imidazole (0.04) | 0.04 | 0.05 |
| I-3 | 100 | Imidazole (0.04) | 0.04 | 0.05 |
| I-4 | 100 | Imidazole (0.04) | 0.03 | 0.04 |
| I-5 | 100 | Imidazole (0.04) | 0.01 | 0.02 |
| I-6 | 100 | Imidazole (0.04) | 0.01 | 0.01 |
| I-7 | 100 | Imidazole (0.04) | 0.01 | 0.02 |
| I-8 | 100 | Imidazole (0.04) | 0.01 | 0.02 |
| I-9 | 100 | Imidazole (0.04) | 0.01 | 0.01 |
| I-10 | 100 | Imidazole (0.04) | 0.01 | 0.02 |
| I-11 | 100 | 2-methylimidazole (0.04) | 0.03 | 0.03 |
| I-12 | 100 | Trisodim phosphate (12 H₂O) | 0.03 | 0.04 |
| | | (0.04) | | |
| I-13 | 100 | Sodium hexametaphosphate | 0.03 | 0.03 |
| | | (0.04) | | |
| I-14 | 100 | Methylenediphosphonic acid | 0.02 | 0.04 |
| | | (0.04) | | |
| I-15 | 100 | Imidazole (0.08) | 0.03 | 0.03 |
| I-16 | 100 | Trisodim phosphate (12 H₂O) | 0.03 | 0.04 |
| | | (0.08) | | |
| I-17 | 100 | Imidazole (0.02)/Trisodim | 0.03 | 0.03 |
| | | phosphate (12 H₂O) (0.02) | | |
| I-18 | 90 | Imidazole (0.04) | 0.02 | 0.04 |
| I-19 | 90 | Imidazole (0.04) | 0.02 | 0.04 |
| I-20 | 80 | Imidazole (0.04) | 0.03 | 0.04 |
| I-21 | 80 | Imidazole (0.04) | 0.03 | 0.04 |
| I-22 | 100 | — | 0.09 | 0.09 |
| I-23 | 100 | Imidazole (0.04) | 0.09 | 0.1 |
| I-24 | 100 | Imidazole (0.04) | 0.1 | 0.11 |
| I-25 | 100 | Sodium hexametaphosphate | 0.07 | 0.09 |
| | | (0.04) | | |
| I-26 | 100 | Trisodim phosphate (12 H₂O) | 0.08 | 0.1 |
| | | (0.04) | | |
| I-27 | 70 | Imidazole (0.04) | 0.07 | 0.08 |
| I-28 | 70 | Imidazole (0.04) | 0.08 | 0.09 |
| I-29 | 60 | Imidazole (0.04) | 0.09 | 0.11 |
| I-30 | 60 | Imidazole (0.04) | 0.08 | 0.1 |

*1: aminopolycarboxylic acid iron (III) complex
*2: aminopolycarboxylic acid iron (II) complex
EDTA-Fe·NH₄: ammonium ethylenediaminetetraacetic acid iron(III) complex
DTPA-Fe·NH₄: ammonium diethylenetriaminepentaacetic acid iron(III) complex
s,s-EDDS-Fe·NH₄: ammonium ethylenediaminedisuccinic acid iron(III) complex
EDTA-Fe: Ethylenediaminetetraacetic acid iron(II) complex

In the Table 1, s,s-EDDS-Fe.NH₄ represents [s,s] optical isomer. As apparent from Table 1, it was proved that the use of a concentrated bleach-fixer composition according to this invention resulted in superior print background white in the running process and improvement in staining due to aging. It was further proved that the use of packaging material for container, exhibiting an oxygen permeability of not more than 50 ml/m² day, or the Fe(II) ratio of not less than 80 mol % led to further enhanced effects.

### Example 2

Concentrated bleach-fixer compositions were prepared similarly to Expt. No. I-7 in Example 1 to prepare single-part concentrated bleach-fixer composition, provided that aminopolycarboxylic acid iron(III) complex included in the composition was varied as shown in Table 2. The thus prepared bleach-fixer kits were stored similarly to Example 1 and then diluted to 2.0 times with water to prepare a bleach-fixer replenishing solution. Running process was carried out similarly to Example 1, using a modified automatic processor of NPS-808 GOLD, in which the respective stabilizing times were varied to 17 sec. (total 51 sec.). Evaluation was also made similarly to Example 1. Results are shown in Table 2.

TABLE 2

| | Aminopolycarboxylic | EDTA | Photographic | |
|---|---|---|---|---|
| Expt. | Acid Fe(III) Complex | Ratio | Quality | |
| No. | (mol/l) | (mol %) | Whiteness | Stain |
| II-1 | EDTA-FeNH₄(0.18) | 100 | 0.02 | 0.02 |
| II-2 | EDTA-FeNH₄(0.162)/ | 95 | 0.03 | 0.03 |
| | DTPA-FeNH₄(0.018) | | | |
| II-3 | EDTA-FeNH₄(0.162)/ | 95 | 0.03 | 0.03 |
| | s,s-EDDS-FeNH₄(0.018) | | | |
| II-4 | EDTA-FeNH₄(0.144)/ | 90 | 0.03 | 0.04 |
| | DTPA-FeNH₄(0.036) | | | |
| II-5 | EDTA-FeNH₄(0.144)/ | 90 | 0.04 | 0.04 |
| | s,s-EDDS-FeNH₄(0.036) | | | |
| II-6 | EDTA-FeNH₄(0.108)/ | 80 | 0.05 | 0.05 |
| | DTPA-FeNH₄(0.072) | | | |
| II-7 | EDTA-FeNH₄(0.108)/ | 80 | 0.05 | 0.05 |
| | s,s-EDDS-FeNH₄(0.072) | | | |

As can be seen from Table 2, it was proved that constitution of substantially 100 mol % of Ethylenediaminetetraacetic acid ratio resulted in further enhanced effects.

### Example 3

Concentrated bleach-fixer compositions were prepared similarly to Expt. No. I-6 in Example 1 to prepare single-part concentrated bleach-fixer composition, provided that the quantity of aminopolycarboxylic acid iron(III) complex included in the composition was varied as shown in Table 3. The thus prepared bleach-fixer kits were stored for 12 months similarly to Example 1 and then diluted to 2.0 times with water to prepare a bleach-fixer replenishing solution. Running process was carried out similarly to Example 1, provided that the processing amount per day was varied to 0.05 R. Evaluation was made similarly to Example 1. Results are shown In Table 3.

TABLE 3

| | | | |
|---|---|---|---|
| Expt. | EDTA | Ratio of EDTA | Photographic Quality |

| No. | (mol/l) | to Iron Ion | Whiteness | Stain |
|---|---|---|---|---|
| III-1 | 0.36 | 1 | 0.05 | 0.05 |
| III-2 | 0.3636 | 1.01 | 0.03 | 0.03 |
| III-3 | 0.3672 | 1.02 | 0.01 | 0.02 |
| III-4 | 0.378 | 1.05 | 0.01 | 0.01 |
| III-5 | 0.3816 | 1.06 | 0.01 | 0.01 |
| III-6 | 0.3852 | 1.07 | 0.02 | 0.03 |
| III-7 | 0.3888 | 1.08 | 0.03 | 0.03 |
| III-8 | 0.3924 | 1.09 | 0.05 | 0.05 |
| III-9 | 0.3852 | 1.1 | 0.05 | 0.05 |

As can be seen from Table 3, it was proved that allowing the ratio of aminopolycarboxylic acid such as ethylenediaminetetraacetic acid (EDTA) to fall with the range of 1.01:1.00 to 1.08:1.00 was specifically preferred, resulting in further enhanced effects of this invention in processing at a relatively small processing volume per day, so-called low processing.

### Example 4

### Preparation of Concentrated Bleach-fixer Composition

Similarly to Example 1. single-part type concentrated bleach-fixer compositions were prepared according to the formula shown belows, so as to meet the Fe(II) ratio, as shown in Table 4. The prepared compositions were each sealed at a free volume of 20% in a polyethylene bottle (HDPE bottle) to prepare a single part package of concentrated bleach-fixer composition (kit).

Concentrated Bleach-fixer Composition

| Ammonium sulfite (40 wt/vol %) | 0.58 mol |
|---|---|
| Ammonium thiosulfate (75 wt/vol %) | 1.1 mol |
| Aminopolycarboxylic acid iron(III) | |
| complex, as shown in Table 1 | |
| Aminopolycarboxylic acid iron(II) | |
| complex, as shown in Table 4 | |
| Additive, as shown in Table 4 | |
| pH | 5.5 |

Water was added to make 1 liter and the pH was adjusted with an aqueous ammonia solution or 50% sulfuric acid.

The foregoing aminopolycarboxylic acid iron(II) complex was prepared by adding iron(II) sulfate (hexa-hydrate) and an aminopolycarboxylic acid of 1.05 molar times the iron(II) sulfate and dissolving them with stirring.

The concentrated bleach-fixer composition packages (kit) were stored under an environment of air temperature 50° C. over a period of two weeks. Similarly to Example 1, the concentrated bleach-fixer compositions were each diluted to 2.0 times with water to prepare a bleach-fixer replenishing solution. Using these replenishing solutions, photographic color paper material was continuously processed according to the procedure described below. The bleach-fixer replenishing solution was also used as a tank solution.

Exposure and Processing

Photographic color paper, Konica Color QA Paper Type A (available from Konica Corp.) was exposed and processed similarly to Example 1.

### Evaluation

Edge Stain

After completion of running process of 2R, unexposed 50 sheets of Konica Color QA Paper Type A7 Paper (L-size) was further processed and edge portions of all four edges (4 points) were measured using X-rite densitometer with respect to reflection blue density and an average value thereof was determined. Edge staining was evaluated based on the following criteria:

A: blue density of not more than 0.10,

B: blue density of more than 0.10 and not more than 0.15,

C: blue density of more than 0.15 and not more than 0.20,

D: blue density of more than 0.20 and not more than 0.25,

E: blue density of more than 0.25.

In the foregoing, A, B and C are acceptable levels in practical use. Evaluation results are shown in Table 4.

TABLE 4

| Expt. | Fe(III) Complex*¹ | Fe(II) Complex*² | Fe(II) Ratio | Compound | Edge Stain | |
|---|---|---|---|---|---|---|
| No. | (mol) | (mol) | (mol %) | (mol %) | Density | Evaluation |
| No.1 | EDTA-Fe.NH₄(3) | — | 0 | — (0) | 0.35 | E |
| No.2 | EDTA-Fe.NH₄(3) | — | 0 | I-1(0.5) | 0.29 | E |
| No.3 | EDTA-Fe.NH₄(3) | — | 0 | I-1(1) | 0.26 | E |
| No.4 | EDTA-Fe.NH₄(3) | — | 0 | I-1(2) | 0.26 | E |
| No.5 | EDTA-Fe.NH₄(3) | — | 0 | I-1(3) | 0.25 | E |
| No.6 | EDTA-Fe.NH₄(3) | — | 0 | I-1(4) | 0.25 | E |
| No.7 | EDTA-Fe.NH₄(2.4) | EDTA-Fe.NH₄(0.6) | 20 | — (0) | 0.29 | E |
| No.8 | EDTA-Fe.NH₄(1.8) | EDTA-Fe.NH₄(1.2) | 40 | — (0) | 0.28 | E |
| No.9 | EDTA-Fe.NH₄(1.5) | EDTA-Fe.NH₄(1.5) | 50 | — (0) | 0.27 | E |
| No.10 | DTPA-Fe.NH₄(1.5) | DTPA-Fe.NH₄(1.5) | 50 | — (0) | 0.27 | E |
| No.11 | EDDS-Fe.NH₄(1.5) | EDDS-Fe.NH₄(1.5) | 50 | — (0) | 0.27 | E |
| No.12 | EDTA-Fe.NH₄(1.2) | EDTA-Fe.NH₄(1.8) | 60 | — (0) | 0.26 | E |
| No.13 | EDTA-Fe.NH₄(0.6) | EDTA-Fe.NH₄(2.4) | 80 | — (0) | 0.26 | E |
| No.14 | — (0) | EDTA-Fe.NH₄(3) | 100 | — (0) | 0.26 | E |
| No.15 | EDTA-Fe.NH₄(2.4) | EDTA-Fe.NH₄(0.6) | 20 | I-1(2) | 0.22 | D |
| No.16 | EDTA-Fe.NH₄(1.8) | EDTA-Fe.NH₄(1.2) | 40 | I-1(2) | 0.21 | D |
| No.17 | EDTA-Fe.NH₄(1.5) | EDTA-Fe.NH₄(1.5) | 50 | I-1(0.5) | 0.18 | C |
| No.18 | EDTA-Fe.NH₄(1.5) | EDTA-Fe.NH₄(1.5) | 50 | I-1(1) | 0.16 | C |
| No.19 | EDTA-Fe.NH₄(1.5) | EDTA-Fe.NH₄(1.5) | 50 | I-1(2) | 0.14 | B |
| No.20 | EDTA-Fe.NH₄(1.5) | EDTA-Fe.NH₄(1.5) | 50 | I-1(3) | 0.12 | B |
| No.21 | EDTA-Fe.NH₄(1.5) | EDTA-Fe.NH₄(1.5) | 50 | I-1(4) | 0.1 | A |
| No.22 | DTPA-Fe.NH₄(1.5) | DTPA-Fe.NH₄(1.5) | 50 | I-1(2) | 0.13 | B |
| No.23 | EDDS-Fe.NH₄(1.5) | EDDS-Fe.NH₄(1.5) | 50 | I-1(2) | 0.13 | B |
| No.24 | EDTA-Fe.NH₄(1.2) | EDTA-Fe.NH₄(1.8) | 60 | I-1(2) | 0.12 | B |
| No.25 | EDTA-Fe.NH₄(0.6) | EDTA-Fe.NH₄(2.4) | 80 | I-1(2) | 0.1 | A |
| No.26 | — (0) | EDTA-Fe.NH₄(3) | 100 | I-1(2) | 0.08 | A |
| No.27 | EDTA-Fe.NH₄(1.5) | EDTA-Fe.NH₄(1.5) | 50 | I-2(2) | 0.14 | B |
| No.28 | EDTA-Fe.NH₄(1.5) | EDTA-Fe.NH₄(1.5) | 50 | I-3(2) | 0.14 | B |
| No.29 | EDTA-Fe.NH₄(1.5) | EDTA-Fe.NH₄(1.5) | 50 | I-4(2) | 0.13 | B |
| No.30 | EDTA-Fe.NH₄(1.5) | EDTA-Fe.NH₄(1.5) | 50 | I-5(2) | 0.13 | B |
| No.31 | EDTA-Fe.NH₄(1.5) | EDTA-Fe.NH₄(1.5) | 50 | I-6(2) | 0.14 | B |
| No.32 | EDTA-Fe.NH₄(1.5) | EDTA-Fe.NH₄(1.5) | 50 | I-7(2) | 0.13 | B |
| No.33 | EDTA-Fe.NH₄(1.5) | EDTA-Fe.NH₄(1.5) | 50 | I-8(2) | 0.14 | B |
| No.34 | EDTA-Fe.NH₄(1.5) | EDTA-Fe.NH₄(1.5) | 50 | I-9(2) | 0.14 | B |
| No.35 | EDTA-Fe.NH₄(1.5) | EDTA-Fe.NH₄(1.5) | 50 | I-10(2) | 0.13 | B |
| No.36 | EDTA-Fe.NH₄(1.5) | EDTA-Fe.NH₄(1.5) | 50 | I-11(2) | 0.13 | B |
| No.37 | EDTA-Fe.NH₄(1.5) | EDTA-Fe.NH₄(1.5) | 50 | I-12(2) | 0.14 | B |
| No.38 | EDTA-Fe.NH₄(1.5) | EDTA-Fe.NH₄(1.5) | 50 | I-13(2) | 0.14 | B |
| No.39 | EDTA-Fe.NH₄(1.5) | EDTA-Fe.NH₄(1.5) | 50 | I-14(2) | 0.13 | B |
| No.40 | EDTA-Fe.NH₄(1.5) | EDTA-Fe.NH₄(1.5) | 50 | I-15(2) | 0.13 | B |
| No.41 | EDTA-Fe.NH₄(1.5) | EDTA-Fe.NH₄(1.5) | 50 | I-16(2) | 0.13 | B |
| No.42 | EDTA-Fe.NH₄(1.5) | EDTA-Fe.NH₄(1.5) | 50 | I-17(2) | 0.13 | B |
| No.43 | EDTA-Fe.NH₄(1.5) | EDTA-Fe.NH₄(1.5) | 50 | II-1(2) | 0.18 | C |
| No.44 | EDTA-Fe.NH₄(1.5) | EDTA-Fe.NH₄(1.5) | 50 | II-9(2) | 0.19 | C |
| No.45 | EDTA-Fe.NH₄(1.5) | EDTA-Fe.NH₄(1.5) | 50 | II-20(2) | 0.17 | C |
| No.46 | EDTA-Fe.NH₄(1.5) | EDTA-Fe.NH₄(1.5) | 50 | II-45(2) | 0.17 | C |
| No.47 | EDTA-Fe.NN4(1.5) | EDTA-Fe.NH₄(1.5) | 50 | II-46(2) | 0.17 | C |
| No.48 | EDTA-Fe.NH₄(1.5) | EDTA-Fe.NH₄(1.5) | 50 | III-1(2) | 0.19 | C |
| No.49 | EDTA-Fe.NH₄(1.5) | EDTA-Fe.NH₄(1.5) | 50 | III-3(2) | 0.19 | C |
| No.50 | EDTA-Fe.NH₄(1.5) | EDTA-Fe.NH₄(1.5) | 50 | III-5(2) | 0.19 | C |
| No.51 | EDTA-Fe.NH₄(1.5) | EDTA-Fe.NH₄(1.5) | 50 | III-8(2) | 0.19 | C |
| No.52 | EDTA-Fe.NH₄(1.5) | EDTA-Fe.NH₄(1.5) | 50 | III-10(2) | 0.19 | C |

*¹Aminopolycarboxylic acid iron(III) complex
*²Aminopolycarboxylic acid iron(II) complex

As can be seen from Table 4, it was proved that the combination an aminopolycarboxylic acid iron complex having a Fe(II) ratio of at least 50 mol % and at least one of compounds of formulas (I), (II) and (III) resulted in synergic effects. The higher Fe(II) ratio is preferred and the Fe(II) ratio of at least 80 mol % is more preferred. Any kind of aminopolycarboxylic acid iron complex led to superior results. It was noted that the use of compounds I-1 through I-17 is more preferred, leading to superior results.

### Example 5

Concentrated bleach-fixer composition packages (kit) were prepared similarly to Expt. No. 19 in Example 4, except that the pH of the composition was varied using aqueous ammonia or 50% sulfuric acid. Similarly to Examples 4, after stored at high temperature, the concentrated bleach-fixer composition were used in running process and evaluated with respect to edge staining. Results are shown in Table 5.

TABLE 5

| Expt. | Fe(III) Complex*¹ | Fe(II) Complex*² | Fe(II) Ratio | Compound | | Edge Stain | |
|---|---|---|---|---|---|---|---|
| No. | (mol) | (mol) | (mol %) | (μmol %) | pH | Density | Evaluation |
| No.19 | EDTA-Fe.NH₄(1.5) | EDTA-Fe.NH₄(1.5) | 50 | I-1(2) | 5.5 | 0.14 | B |
| No.61 | EDTA-Fe.NH₄(1.5) | EDTA-Fe.NH₄(1.5) | 50 | I-1(2) | 3 | 0.18 | C |
| No.62 | EDTA-Fe.NH₄(1.5) | EDTA-Fe.NH₄(1.5) | 50 | I-1(2) | 3.5 | 0.16 | C |
| No.63 | EDTA-Fe.NH₄(1.5) | EDTA-Fe.NH₄(1.5) | 50 | I-1(2) | 4 | 0.15 | B |
| No.64 | EDTA-Fe.NH₄(1.5) | EDTA-Fe.NH₄(1.5) | 50 | I-1(2) | 5 | 0.14 | B |
| No.65 | EDTA-Fe.NH₄(1.5) | EDTA-Fe.NH₄(1.5) | 50 | I-1(2) | 6 | 0.13 | B |
| No.66 | EDTA-Fe.NH₄(1.5) | EDTA-Fe.NH₄(1.5) | 50 | I-1(2) | 7 | 0.15 | B |
| No.67 | EDTA-Fe.NH₄(1.5) | EDTA-Fe.NH₄(1.5) | 50 | I-1(2) | 7.5 | 0.17 | C |
| No.68 | EDTA-Fe.NH₄(1.5) | EDTA-Fe.NH₄(1.5) | 50 | I-1(2) | 8 | 0.18 | C |

*¹Aminopolycarboxylic acid iron(III) complex
*²Aminopolycarboxylic acid iron(II) complex

As apparent from Table 5, it was proved that the pH of 4 to 7 led to superior results of this invention.

### Example 6

Concentrated bleach-fixer composition packages (kit) were prepared similarly to Expt. No. 19 in Example 4, except that a nitrate salt was further added, as shown in Table 6. Similarly to Examples 4, after stored at high temperature, the concentrated bleach-fixer composition were used in running process and evaluated with respect to edge staining. Results are shown in Table 6.

TABLE 6

| | |
|---|---|
| Expt. | Edge Stain |

| No. | Nitrate (mol %*) | Density | Evaluation |
|---|---|---|---|
| No. 19 | —(7) | 0.14 | B |
| No. 71 | NaNO₃ (7) | 0.12 | B |
| No. 72 | KNO₃ (7) | 0.11 | B |
| No. 73 | NH₄NO₃ (3) | 0.12 | B |
| No. 74 | NH₄NO₃ (4) | 0.11 | B |
| No. 75 | NH₄NO₃ (5) | 0.08 | A |
| No. 76 | NH₄NO₃ (7) | 0.07 | A |
| No. 77 | NH₄NO₃ (10) | 0.09 | A |
| No. 78 | NH₄NO₃ (12) | 0.12 | B |

As apparent from Table 6, it was proved that the use of nitrate salts led to further enhanced effects this invention. It was also noted that the molar ratio of a nitrate salt was preferred within the range of 5 to 10 mol %.

What is claimed is:

1. A concentrated bleach-fixer composition for a silver halide color photographic material, comprising an aminopolycarboxylic acid iron complex and a thiosulfate, wherein the bleach-fixer composition further comprises at least one compound selected from the group consisting of a phosphate salt, polyphosphate salt, an imidazole compound and a diaminotriazine compound; and the aminopolycarboxylic acid iron complex having a Fe(II) ratio of not less than 50 mol %.

2. The bleach-fixer composition of claim 1, wherein said at least one compound is selected from the group consisting of a phosphate salt, polyphosphate salt, an imidazole compound, and the imidazole compound is a compound represented by the following formula (1) or its derivative:
(R1)ₙA formula (1)
wherein R1 is a hydrogen atom, an alkyl group having 1 to 3 carbon atom which may be substituted by an amino group or hydroxy group, an alkenyl group or a halogen atom; n is an integer of 1 to 3; A is an imidazole moiety.

3. The bleach-fixer composition of claim 1, wherein said at least one compound is selected from the group consisting of a diaminotriazine compound and the diaminotriazine compound is represented by the following formula (I), (II) or (III): 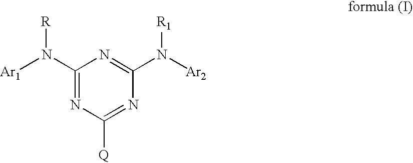
wherein Ar₁ and Ar₂ are independently an aromatic carbocyclic group or an aromatic heterocyclic group, provided that at least one of Ar₁ and Ar₂ contains at least two water-solubilizing groups or each of Ar₁ and Ar₂ contains at least one water-solubilizing group; Q is a hydrogen atom, hydroxy group, mercapto group, carboxyl group, sulfo group, —NR₂R₃, —OR₂ or a halogen atom, in which R₂ and R₃ are each a hydrogen atom, an alkyl group or a phenyl group; R and R₁ are independently an alkyl group having 1 to 3 carbon atom or a hydroxyalkyl group having 1 to 3 carbon atoms; 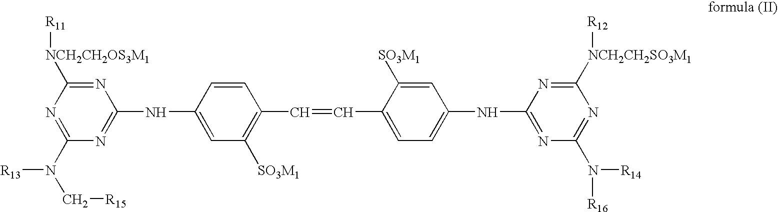
wherein R₁₁ and R₁₂ are independently a hydrogen atom or an alkyl group; R₁₃ and R₁₄ are independently a hydrogen atom, an alkyl group or an aryl group; R₁₅ is an alkyl group containing at least one asymmetric carbon atom or a group represented by the following formula (II-a); R₁₆ is an alkyl group containing at least one asymmetric carbon atom or a group represented by the following formula (II-b); M₁ is a hydrogen atom, an alkali metal atom, an alkaline earth metal atom, ammonium group or a pyridinium group; provided that R₁₃ and R₁₅, or R₁₄ and R₁₆ may combine with each other to form a ring:
—CH₂O(CH₂CH₂O)ₙ₁₁H formula (II-a)
wherein n11 is an integer of 1 to 3;
—(CH₂CH₂O)ₙ₁₂H formula (II-b)
wherein n12 is an integer of 2 to 4; 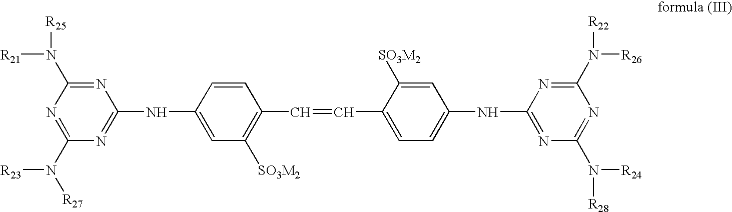
wherein R₂₁, R₂₂, R₂₃ and R₂₄ are independently a hydrogen atom, an alkyl group or an aryl group; R₂₅ and R₂₆ are independently an alkyl group containing at least one asymmetric carbon atom or a group represented by the following formula (III-a); R₂₇ and R₂₈ are independently an alkyl group containing at least one asymmetric carbon atom; M₂ is a hydrogen atom, an alkali metal atom, an alkaline earth metal atom, ammonium group or a pyridinium group; provided that R₂₁ and R₂₅, R₂₂ and R₂₆, R₂₃ and R₂₇, or R₂₄ and R₂₈ may combine with each other to form a ring:
—(CH₂CH₂O)ₙ₂₁H formula (III-a)
wherein n21 is an integer of 2 to 4.

4. The bleach-fixer composition of claim 3, wherein the diaminotriazine compound is selected from the group consisting of the following compounds of I-1 through I-17:

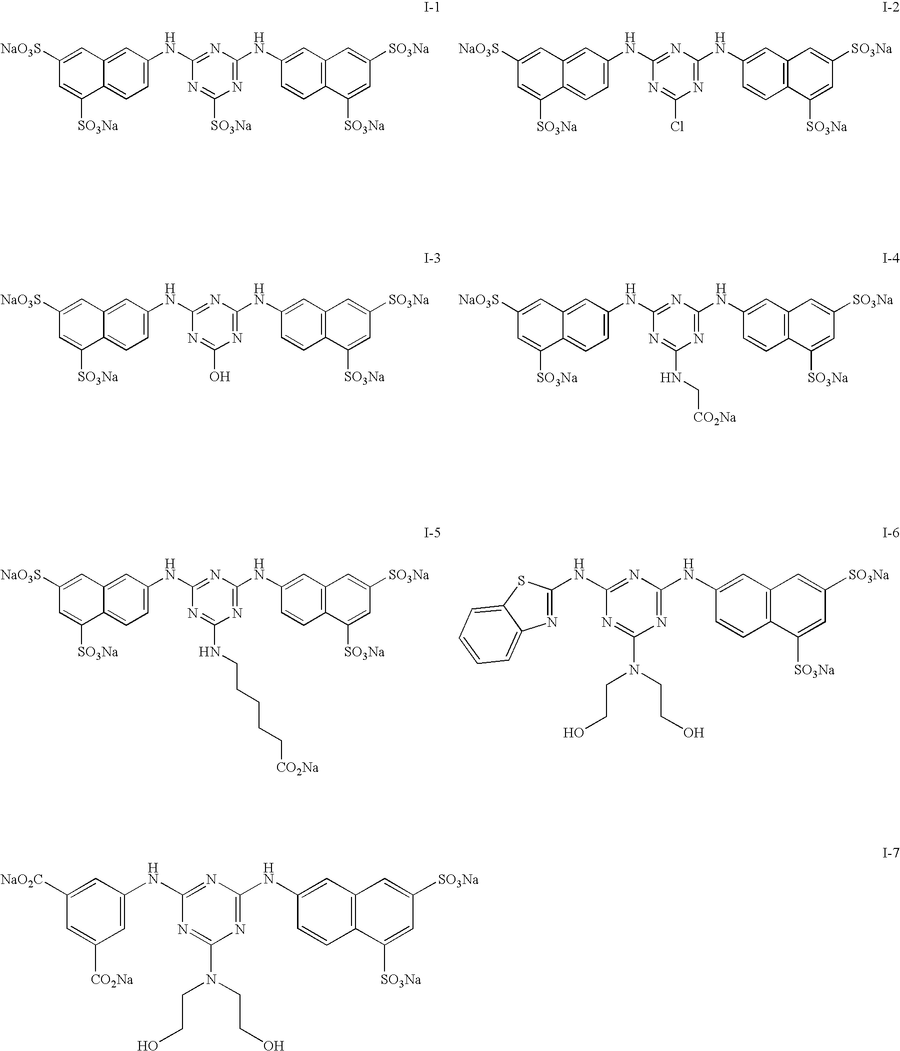

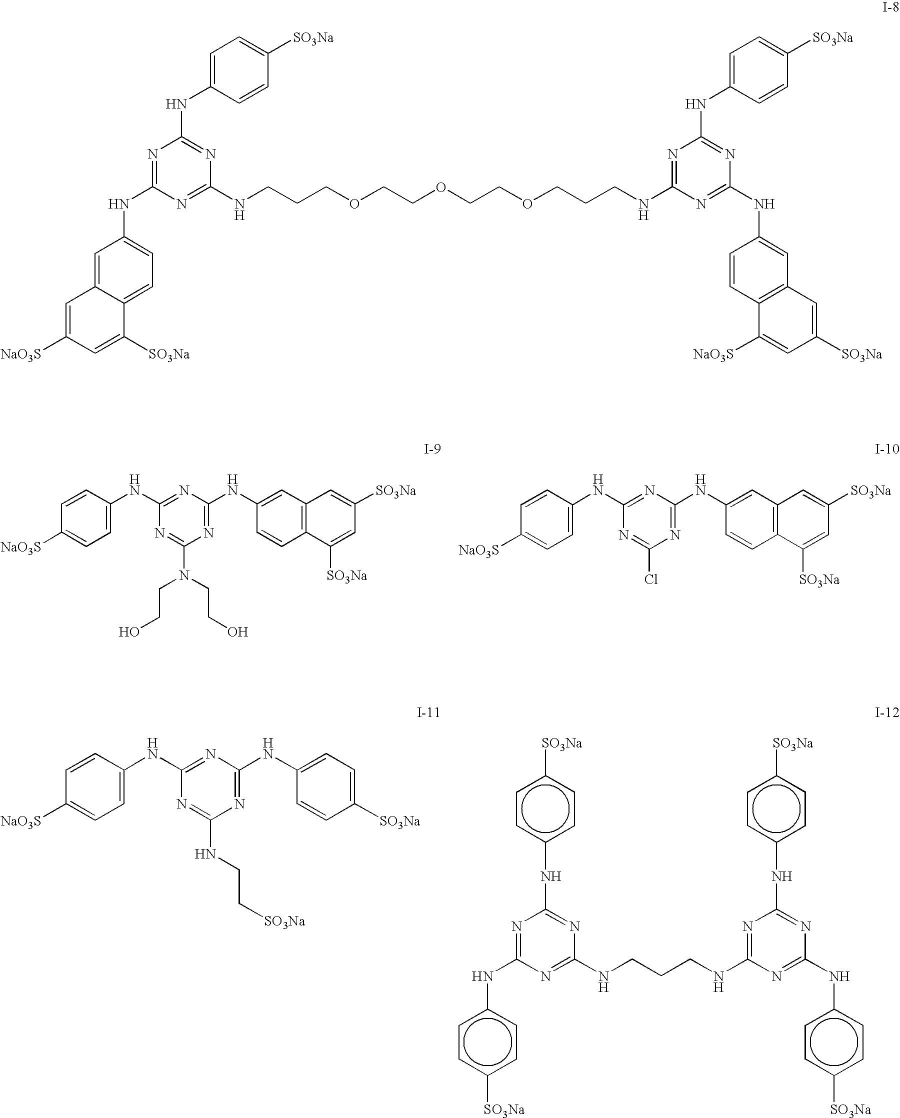

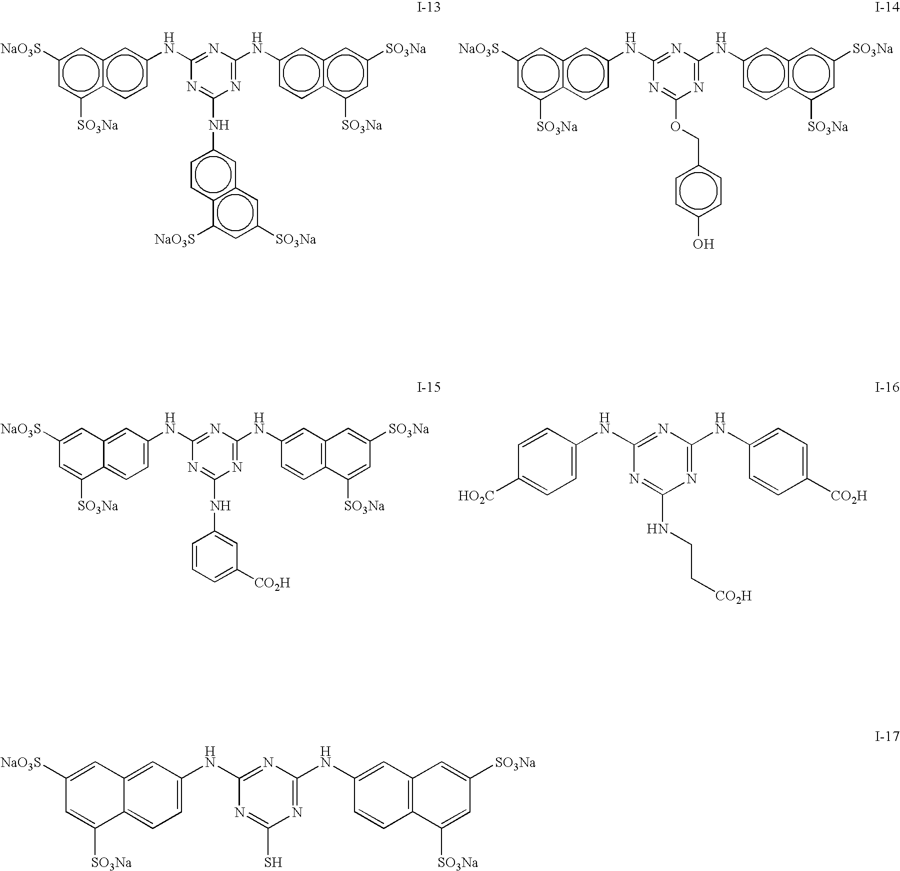

5. The bleach-fixer composition of claim 1, wherein the aminopolycarboxylic acid iron complex has a Fe(II) ratio of not less than 80 mol %.

6. The bleach-fixer composition of claim 1, wherein a molar ratio of aminopolycarboxylic acid ligand to iron is within the range of 1.01:1.00 to 1.08:1.00.

7. The bleach-fixer composition of claim 1, wherein the bleach-fixer composition exhibits a pH of 4 to 7.

8. The bleach-fixer composition of claim 2, wherein at least 80 mol % of an aminopolycarboxylic acid ligand is accounted for by ethylenediaminetetraacetic acid.

9. The bleach-fixer composition of claim 8, wherein 100 mol % of an aminopolycarboxylic acid ligand is ethylenediaminetetraacetic acid.

10. The bleach-fixer composition of claim 3, wherein the bleach-fixer composition comprises a nitrate salt.

11. The bleach-fixer composition of claim 10, wherein the nitrate salt is in an amount of 5 to 10 mol % of the aminopolycarboxylic acid iron complex.

12. A method of processing a silver halide color photographic material comprising bleach-fixing an imagewise exposed and developed silver halide photographic material with a bleach-fixer composition as claimed in claim 1.
